(19) United States
(12) Patent Application Publication
(10) Pub. No.: US 2023/0281643 A1
(43) Pub. Date: Sep. 7, 2023

(54) DECISION SUPPORT SYSTEM FOR MARKETING MIX MODELING

(71) Applicant: IQVIA Inc., PARSIPPANY, NJ (US)

(72) Inventors: Sourav Dutta, Bangalore (IN); Sunil Kumar Singh, Kerala (IN); Sriram Subramani, Bangalore (IN); Sunil Sreedharan, Bangalore (IN); Anil Kharde, Maharashtra (IN)

(21) Appl. No.: 17/683,894

(22) Filed: Mar. 1, 2022

(51) Int. Cl. G06Q 30/02

(52) U.S. Cl. CPC G06Q 30/0201; G06Q 30/0202

(57) ABSTRACT

Methods, systems, and apparatus, including computer programs encoded on computer storage media, for generating models. In some implementations, a system obtains data that comprises promotions and parameters for an opportunity. The system generates transformation spaces based on the promotions and the parameters, wherein each transformation space comprises states, each state is based on the parameters for a particular promotion. The system iterates over a number of iterations. For each transformation space, the system adjusts a state of the transformation space based on actions. The system generates a model by combining each adjusted state. The system generates an entropy for the model. The system compares the entropy to a threshold value, wherein the threshold value corresponds to one of the parameters. In response to determining that the entropy exceeds the threshold value, the system iterates. The system provides the generated model for output.

### TECHNICAL FIELD

This specification relates to computer predictions, and one particular implementation relates to generating a model for quantifying promotional impact on a sale of a product or service.

### BACKGROUND

Currently, there exists a need to intelligently support organization decision making as they navigate a potential sale opportunity by way of a variety of promotions for the sale opportunity. A sales opportunity can take organizations on a journey through developing one or more promotions to aid in the selling of the sale opportunity. As such, when an important business decision arrives, it is common for decisions to be made to support the sale opportunity.

### SUMMARY

The techniques in this specification describe building models to understand and quantify the impact of various promotions on sales and apply identified promotional techniques of a product or service. In particular, the techniques rely on enhancements to a process known as marketing mix modeling (MMM), to aid in the understanding of how various promotions can impact an opportunity. Additionally, the MMM analysis can analyze various characteristics or effects of a promotion, such as lag, saturation, and decay, to determine how such processes can have an impact on a potential opportunity, such as a contract, a service, a product, a sale, or other aspects. MMM analysis is an analytical approach that relies on promotional data to quantify the impact of corresponding promotions on an activity. Large organizations may identify their promotional spending or promotional activities for an opportunity to determine and measure effectiveness for the opportunity. By analyzing promotional effectiveness on an opportunity, these organizations can take promotional decisions that optimize the attractiveness of the opportunity to potential customers. As will be further described below, this process is performed by establishing a simultaneous relationship of various promotional activities with the opportunity.

For example, a large business may be preparing to a sell a newly designed shoe to the public. In order to maximize profits or maximize the selling of the newly designed shoe to customers, the large business may analyze various promotions that can impact the effectiveness of selling the shoe. These promotions can include different types of advertisement distributed to the public, e.g., web advertisements, emails, commercials on television, brochures, calls, to name a few examples. Each of the promotions can include various characteristics like diminishing returns effect, saturation effect, carry over effect, lag effect, to name a few examples. An individual at the large business can interact with this system described in this specification to generate a model that can be used for identifying specific promotional characteristics that improve the likelihood of maximizing profits when selling the newly designed shoe or maximize the selling of the newly designed shoe.

In some implementations, MMM analysis can analyze the various effects of promotions on an opportunity. The process for analyzing the effects of promotions includes using a server to receive potential promotions from a user and transforming the promotional effects, e.g., lag, saturation, and decay, to standardized data that can be modeled. Ranges of potential values for each of these effects can represent the transformations in an N-dimensional mapping space. The MMM analysis can perform functions on the potential values in the N-dimensional mapping space to determine an optimal set of effects for a potential promotion. However, the mapping space becomes exponentially large as the set of range values increase and the numbers of parameters for the promotional sales grow. Thus, in order to determine parameters that may model a potential opportunity, the server can analyze the mapping space iteratively to arrive at a set of parameters that meet user defined criteria, and subsequently, one that generates a feasible model.

The techniques described below automate and improve the MMM analysis by providing an artificial intelligence based framework that relies on reinforcement learning to generate the right combination of promotional transformation parameters to arrive at a model that satisfies various statistical criteria and desired business objectives for a potential opportunity. In particular, the techniques provide one or more of cognitive techniques, reinforcement learning methods, algorithmic framework, e.g., multi-arm bandit modeling, and information entropy for analyzing and predicting the outcome of industrial advanced analytics projects. The techniques can work in any high dimensional space under a degree of uncertainty to arrive at a model that is below a threshold of uncertainty.

The techniques provided in this specification describe obtaining data from a plurality of resources by a server in a non-standardized format. For example, the non-standardized data can include digital documents, financial documents or transaction, emails, data inputs, and other external documents related to lag, saturation, and decay for various promotions. The server can convert the non-standardized data into a standardized data format, e.g., data values, using a set of modules regardless of the format of the non-standardized data, e.g., data from the plurality of resources. Then, the server can transform the standardized data into a set of promotional standardized values. The promotional standardized values can then be used to generate the transformation spaces. The transformation spaces can be adjusted and iteratively traversed to identify a model, e.g., a set of modeled parameters, that can be used to effectively model promotional effects on a potential marketing opportunity. Moreover, the server can include a machine-learning model that can be trained recursively to identify promotions and likelihood of promotional effectiveness for a potential opportunity.

If the system did not covert the non-standardized data into standardized before processing to generate the transformation spaces, the system would not be able to ascertain the relevant information in the non-standardized data used to generate a model for the potential marketing opportunity. By converting the non-standardized data into standardized data, the system can filter and/or extrapolate unnecessary and not relevant information for identifying the particular model for the potential marketing opportunity.

In one general aspect, a method performed by one or more computers includes: obtaining, by one or more processors, data that comprises promotions and parameters of each promotion for an opportunity; generating, by the one or more processors, one or more transformation spaces based on a number of the promotions and the parameters of each promotion, wherein each of the one or more transformation spaces comprises a plurality of states, each state for a transformation space is based on a combination of the parameters for a particular promotion; for at most a predefined number of iterations: for each of the one or more transformation spaces: adjusting, by the one or more processors, a state of the transformation space based on a set of available actions; generating, by the one or more processors, a model by combining each adjusted state from each of the adjusted transformation spaces; based on the generated metrics, determining, by the one or more processors, an entropy of the model; comparing, by the one or more processors, the entropy of the model to a threshold value; and in response to determining that the entropy exceeds the threshold value, proceeding, by the one or more processors, to the next iteration; and providing, by the one or more processors, the generated model for output to use for the opportunity.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the method includes wherein a number of the one or more transformation spaces correspond to the number of promotions.

In some implementations, the method includes in response to determining that a zero entropy is observed when comparing the entropy to the threshold value, providing, by the one or more processors, the generated model for output to use for the opportunity.

In some implementations, the method includes wherein the parameters of the promotion comprises (i) lag transformation, (ii) adstock transformation, and (iii) fractional root transformation.

In some implementations, the method includes wherein generating the one or more transformation spaces based on the number of the promotions and the parameters of each promotion further includes: generating, by the one or more processors, a first transformation of the lag transformation; generating, by the one or more processors, a second transformation of the adstock transformation; generating, by the one or more processors, a third transformation of the fractional root transformation; and wherein each state for each of the one or more transformation spaces is based on a combination of the first transformation of the lag transformation, the second transformation of the adstock transformation, and the third transformation of the fractional root transformation.

In some implementations, the method includes wherein the generated metrics comprises at least one of volume contribution functions, beta coefficient functions, p-value functions, R-square functions, DW statistic functions, and MAPE functions.

In some implementations, the method includes wherein generating the entropy of the model further includes: generating, by the one or more processors, a distance metric for each of the generated metrics; generating, by the one or more processors, a total summation for each of the generated metrics; generating, by the one or more processors, a second summation that comprises a ratio based on (i) the distance metric for each of the generated metrics and (ii) the total summation; generating, by the one or more processors, the entropy of the model based on an entropy equation and the second summation; generating, by the one or more processors, a reward based on the entropy of the model; generating, by the one or more processors, Q-values corresponding to actions leading to adjustments in the transformation spaces; and storing, by the one or more processors, the Q-values corresponding to a set of prior actions corresponding to a prior adjustment state for each of the transformation spaces in a database.

In some implementations, the method includes identifying, by one or more processors, a random state for each of the one or more transformation spaces such that (i) the random state is chosen as a starting location for exploration through each transformation space during the predefined number of iterations and (ii) the random state is chosen such that exploration can be performed within the predefined number of iterations.

In some implementations, the method includes wherein adjusting the state of the transformation space is based on the set of available actions and performed using an epsilon greedy policy.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram that illustrates an example of a system for generating a model based on reinforcement learning and marketing mix modeling.

FIG. 1B is a block diagram that illustrates an example of a system for generating a model based on reinforcement learning and marketing mix modeling processes consisting of algorithmic and technological framework.

FIGS. 1C and 1D are block diagrams that illustrate examples of flow charts for implementing training a model using reinforcement learning (Temporal Difference Q-leaning), uncertainty reduction principles, response surface methodologies and marketing mix modeling.

FIG. 2 is an example of a transformation space generated by the system for one promotional channel.

FIG. 3 is an example of a state transition for a transformation space using an epsilon greedy policy.

FIG. 4 is an example of a transition between two states of the promotional channel in 2D transformation space.

FIG. 5 is a graphical representation that illustrates a relationship between entropy and a normalized ratio.

FIG. 6 is a graphical representation that illustrates a score for each channel corresponding to a business condition.

FIG. 7 illustrates a transition between states based on Temporal Difference Q-learning (off-policy) for calculating a reward between state transitions.

FIG. 8 is a graphical representation that illustrates a transition between states based on an N-step SARSA policy.

FIG. 9 is a flow diagram that illustrates an example of generating a model based on reinforcement learning and marketing mix modeling.

FIG. 10 is a block diagram that illustrates an example of technological framework for the system that generates a model using reinforcement learning and marketing mix modeling.

FIG. 11 is a flow diagram that illustrates an example of a process of a technical framework for producing a model.

FIG. 12 is a block diagram that illustrates an example of a system for decision support functions for generating a model.

FIGS. 13A-13C are block diagrams that illustrate examples of a system of physical architecture of a decision support system.

FIG. 14 is a graphical representation that illustrates reinforcement learning (RL) entropy reduction for initial episodes.

FIG. 15 is a graphical representation that illustrates RL entropy reductions after 50 episodes.

FIG. 16 is a graphical representation that illustrates episodic Q value update of any random state of any promotional channel for all the actions possible.

FIGS. 17A-17B are examples of user interfaces that enable users to provide parameters for executing simulations to generate a model.

FIG. 18 is a flow diagram that illustrates an example of a process for generating a model that models impacts of promotions on a potential sale opportunity.

FIG. 19 shows a block diagram of a computing system that can be used in connection with methods described in this document.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

The system takes promotional analytical sales data as an input to perform Market Mix Modeling analysis (MMM). MMM analysis is a human centric process and is as much an art as it is a science. For doing MMM analysis, various effects on promotions are to be considered. Modeling promotions considering all these effects is extremely complicated since the promotional data must be transformed. The transformations make the decision space exponentially large, and hence makes it a daunting task for an analyst to arrive at a feasible model by correctly choosing a subset of input from the possible space. The analyst uses experience and learning to iteratively select a set of good transformation parameters. The proposed system is an AI-based system to mimic the human decision-making process for MMM analysis. The system uses the principles of Reinforcement Learning, Information entropy to quantify the goodness of model and Response surface methodology for deciding the path of improvement. The system iteratively performs the set of experiments, learns from the actions, and mimics the human experience-based analysis process. The system takes decision based on reward function, which is constructed with entropy based on multiple business and statistical objectives. At every step, the system quantifies how much it is away from the desired goal and sets itself over a path of improvement. The system makes choices at each step in the iterations based on multi arm bandit principles and arrives at feasible set of solution in reasonable time as compared to human expert.

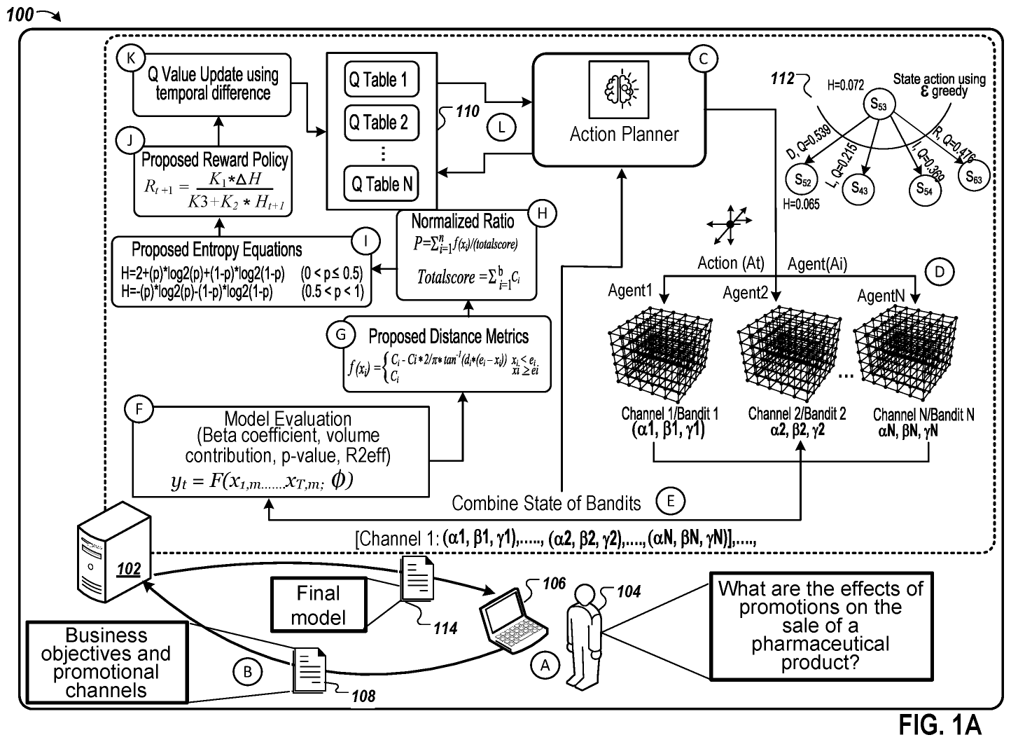

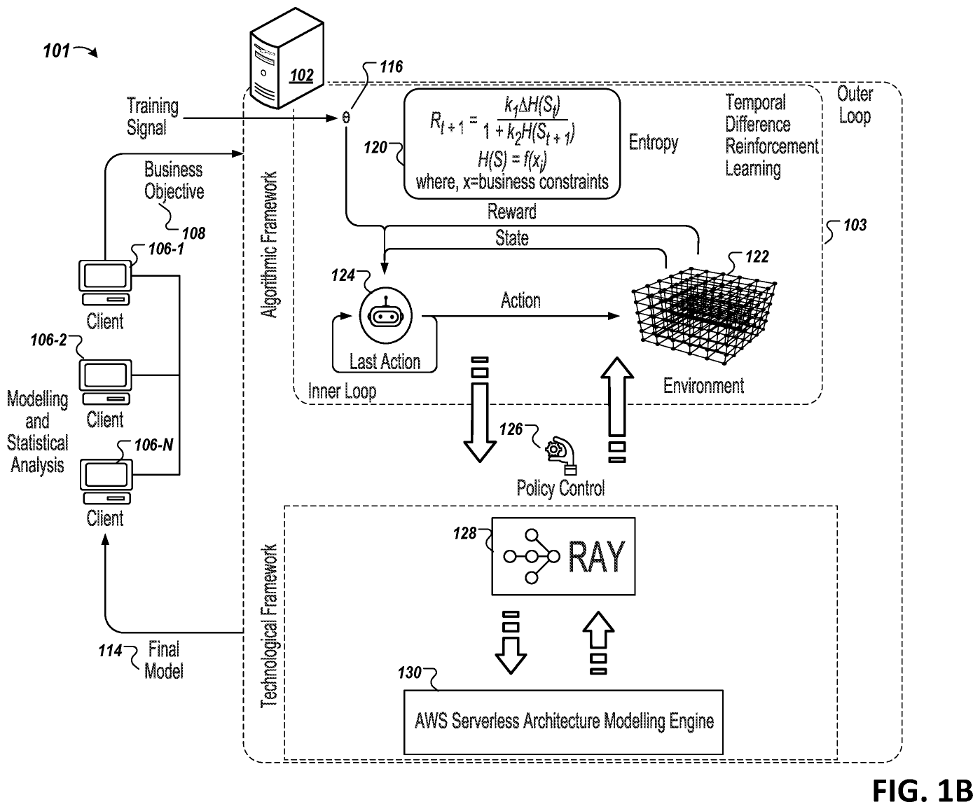

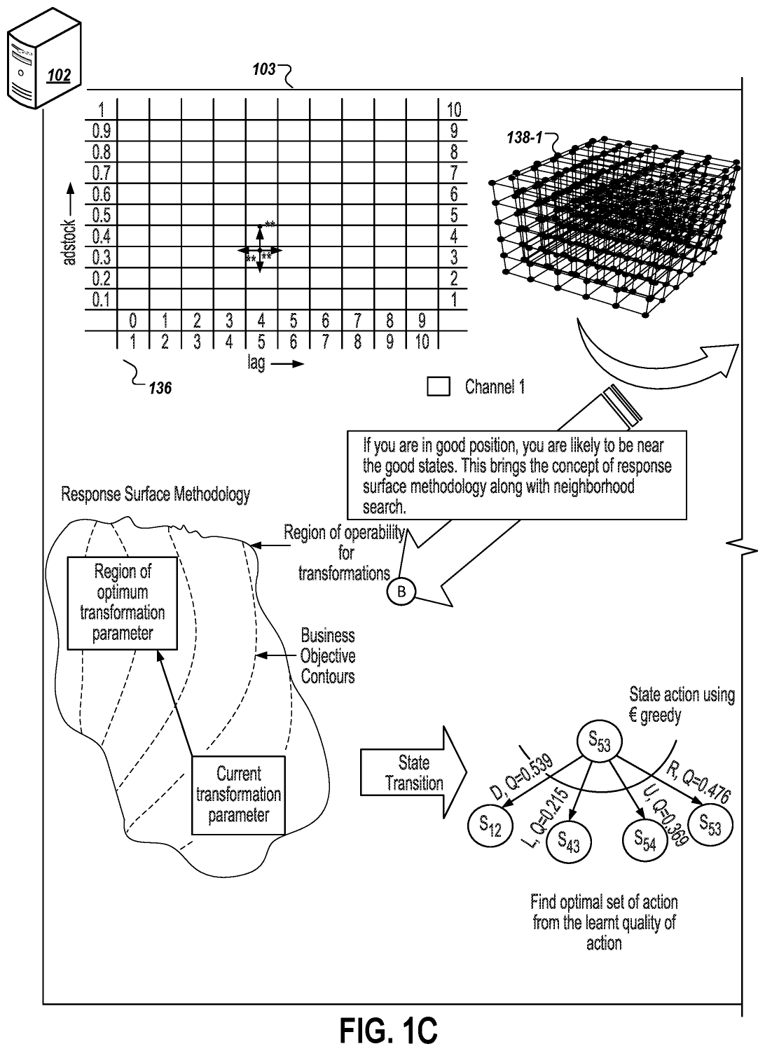

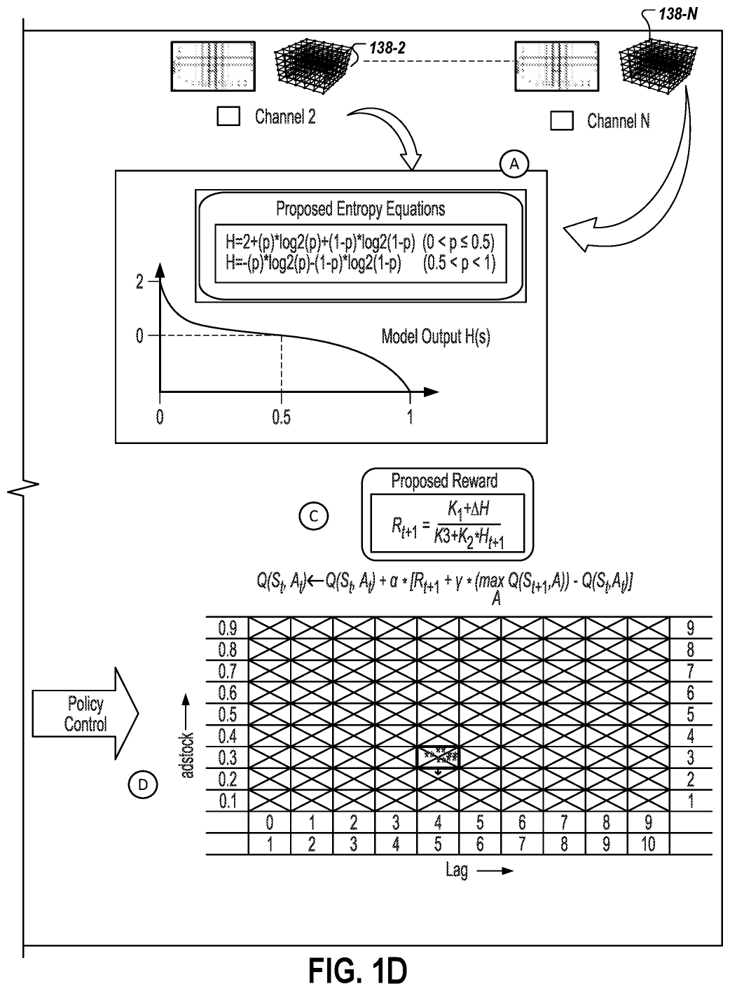

FIG. 1A is a block diagram that illustrates an example of a system 100 for generating a model based on reinforcement learning and marketing mix modeling. System 100 can be a predictive computing system configured to process input promotional data to generate a statistical model with low or zero entropy. The system 100 utilizes advanced artificial intelligence and reinforcement based learning approaches to quantify the impact of various marketing activities on a sale. In particular, the system 100 can generate a model that builds multiple models to determine an optimal approach to promotional activities for the potential sale opportunity. FIG. 1A illustrates various operations in stages (A) though (L) which may be performed in the sequence indicated or another sequence.

The system 100 relies on enhancements to a process known as Marketing Mix Modeling (MMM) to produce such models. MMM describes an analytical statistical approach, such as multivariate regressions on sales and marketing time series data, to estimate the impact of various marketing tactics on sales, and then forecasting the impact of future sets of tactics. For example, MMM analysis can be an analytical approach that uses historic information, such as point-of-sale data and companies' internal data, to quantify the sales impact of various marketing activities. In particular, this is performed by establishing a simultaneous relation of various marketing or promotional activities with the sale, in the form of a linear or a non-linear equation, through a technique of statistical regression.

MMM can define the effectiveness of each of the promotional activities or marketing elements in relation to a sale in terms of its contribution to sales-volume, effectiveness, e.g., volume generated by each unit of effort, efficiency, e.g., sales volume generated divided by cost, and return on investment (ROI). The MMM analysis can then adopt the learnings to adjust marketing tactics and strategies, optimize the marking plan, and can forecast sales while simulating various scenarios.

In particular, the MMM analysis can set up a model with the sales values as the dependent value and independent variables created out of the various promotional activities. As will be further described below, the creation of variables for the MMM analysis requires a complex and intricate process of analyzing large promotional data sets with various ranges. The system 100 can iterate over a predefined number of iterations to create a model which models and describes the volume promotional trends corresponding to a sale activity. The system 100 can output an optimized model that can be used to analyze the impact of the promotional elements with respect to the sales activity over various dimensions.

The contribution of each promotional element as a percentage for a particular time period can be a good indicator of how the effectiveness of various promotional elements change and adapt over the years. This annual change or adaption can be measured by a promotional analysis, which illustrates what percentage of the change in total sales is attributable to each of the promotional elements. For activities such as television advertising and trade promotions, more sophisticated analysis like effectiveness can be carried out. This analysis can lend information of incremental gain in sales that can be obtained by increasing the respective marketing element by one unit. Additionally, if detailed spend information per activity is available, then it is possible to calculate the ROI of the promotional activity. Not only is this information useful for reporting the effectiveness of the promotional activity, but also, this helps to optimize the marketing budget by identifying the most and least effective promotional activities related to a sale opportunity.

Consequently, once the system 100 generates a final model, the results from the final model can be used to simulate and forecast future promotional activities related to the sale opportunity in various “What-if” scenarios. As such, individuals that monitor the promotional activities can allocate or re-allocate marketing budget in different proportions to more efficient promotional activities and see the direct impact on sales. Based on the observed impact on sales, individuals can provide feedback to the system to retrain the model to more effectively generate models that better forecast promotional activities for sales opportunities. In this approach, these individuals can optimize the budget for a particular sale opportunity by allocating spending to those activities which provide the highest return on investment.

However, to enhance MMM analysis, decision support system (DSS) technology can be applied to MMM analysis to enhance its decision-making. In a typical decision model, the response of a sales opportunity to a media or promotional variable activity is assumed a linear response. Such a linear response curve is not able to account for characteristics associated with advertisement activity, e.g., ad saturation and diminishing returns, at high levels of spending, and can be referred to as the shape effect. In order for MMM to consider this nonlinear effect, the system 100 can transform the characteristics associated with the advertisement or promotional activity, such as lag, adstock, and fractional root functions. These parameters can be tuned in order to capture and analyze the actual marketing effect of various promotion activities. In order for the system 100 to build an effective promotional model, the system 100 must explore a range of possible transformation parameters or a range of potential promotional features. However, exploring the range of possible transformation parameters is a time-consuming and complex process during model evaluations. Modeling process considering all these effects is extremely complicated, since it is hard to identify the right transformations to account for these effects on each of the various promotion channels. Billions of possible combinations (and possible models) makes it impossible (NP-Hard problem) for an analyst to arrive at right combinations by handcrafted experiments.

The system 100 performs the following processes to enhance the MMM analysis. First, the system 100 performs the reinforcement learning (RL) based game framework based on a temporal difference (TD) Q-learning algorithm which executes MMM analysis as a set of simultaneous N-dimensional games. Additionally, the system 100 relies on a reward function constructed with entropy based on promotional business objectives such as, volume contribution, beta coefficient, p-value, etc., for each promotional channel.

The system 100 includes a user 104, a client device 106, and a modeling server 102. In some implementations, the client device 106 and the modeling server 102 communicate over a network. The network can include, for example, Wi-Fi, Bluetooth, the Internet, an intranet connection, or some other form of wired or wireless connection. In some implementations, the system 100 may not include a client device 106 and the user 104 may interact directly with the modeling server 102. For example, the user 104 may interact with a user interface of a monitor connected to the modeling server 102 by way of a touch screen and/or a mouse and keyboard configuration. The user 104 can also interact with the client device 106 and/or the modeling server 102 by speaking commands directly to the devices. Other forms of interacting with the client device 106 and the modeling server 102 are also possible.

The modeling server 102 can be a computer system that includes one or more computers or one or more servers, or a combination. The modeling server 102 can include one or more processors, one or more graphical processing units (GPUs), and memory, etc. The modeling server 102 can additionally act as a cloud server for processing data on the cloud. The client device 106 can be, for example, a mobile device, a handheld device, a personal computer, a tablet, or another similar type of device that can communicate with the modeling server 102 over the network.

During stage (A), the user 104 can interact with an interface of the client device 106. For example, the user 104 may seek to determine “What are the effects of promotions on the sale of a pharmaceutical product?” User 104's company may be selling a pharmaceutical product, and in order to maximize profits for selling the product or to sell a desired number of the pharmaceutical product, the user 104 can interact with the modeling server 102 to generate a model that aids in determining optimal promotional parameters that help meet this criteria when selling the pharmaceutical product. The promotions can include, for example, web advertisements, commercials on television, brochures, emails, calls, to name a few examples.

In some implementations, the user 104 can interact with the interface of the client device 106 or the modeling server 102 to generate one or more models for determining various promotional effects on a sale opportunity. In particular, the user 104 can provide data to the interface that instructs the modeling server 102 how to generate and build the statistical models. The data can include algorithm parameters that describe, for example, a number of initial models, a number of episodes, a number of parallel processes, a time frame for building the model, a number of models to output, a number of steps, and a training signal. The data can also include a score level, an expected total volume percentage, an expected total volume percentage for important channels, a volume percentage for each important channel, the available promotional channels, and the important channels.

The number of initial models can describe the number of models initially built for the simulations. The modeling server 102 iterates through stages (C) through (L) in one step. The number of steps represents the number of times the modeling server iterates through stages (C) to stage (L) before termination. In one episode, the modeling server 102 iterates through stage (C) to stage (L) number of steps times. The number of parallel processes can describe a number of parallel threads for the processor of the modeling server 102. The time frame for building the model can describe the number of data points taken into consideration for modeling. The number of models to output can describe the number of models output by the modeling server 102 after the modeling server 102 completes its modeling from all the episodes having a least amount of entropy. The training signal can be set to ON or OFF. The modeling server can set training signal ON in the initial episodes to rapidly learn or update values of the environment. Once there is enough learning, the modeling server can set training signal to OFF. An expected total volume percentage is the sum of volume contribution percentage from all the promotion channels. The available promotion channels can describe the different communication mediums, by which advertisements are pushed out for the particular sale opportunity, e.g., web advertisements, email, and television, to name a few examples. The important channels are the few promotion channels among all channels having considerable amount of share in total volume percentage which the user 104 choose in stage (B). The expected share of volume contribution percent of important channel in expected total volume contribution percentage is the volume percentage of respective important channel which is defined by the user 104 in stage (B). The user 104 can also provide other inputs into the modeling server 102 for aiding the decision support system of the modeling. For example, the inputs can also include data that specifies characteristics of the promotions, e.g., number ranges for lag, number ranges for adstock, and number ranges for fractional transformation.

During stage (B), the client device 106 can transmit the data 108 that includes the business objectives and promotional channel data input by the user 104. The client device 106 can transmit the data 108 to an external database over a network that the modeling server 102 can access for retrieving instructions for simulation. Alternatively, the client device 106 can transmit the data 108 directly to the modeling server 102 over the network. The modeling server 102 can receive the data 108 and use the data 108 to determine how to execute the model building process. In order for the modeling server 102 to execute the model building process, the modeling server 102 can analyze the promotions and transform the promotions to a more standard format for modeling, which will be described below.

In some implementations, promotions for particular sales opportunities can have non-linear effects. Marketers can have difficulty accurately determining the effects of marketing or promotions. Promotions typically exhibit lag effects and diminishing returns, which can be difficult to capture using linear regression modeling. Hence, the system 100 can incorporate the effects of promotions on linear regressions by performing transformations on the promotional data, as will be described below. For example, in certain industrial contexts, such as the pharmaceutical context, lagged, decaying, and saturation effects are observed in promotion sales data. The system 100 can transform lag, adstock, and fractional root transformations to capture the effects in a linear context.

Lag can be described as some marketing strategies having a delayed effect on a sales opportunity. For example, consumers who view the advertisement for a particular sales opportunity may wait a time period, e.g., a day, a week, a few weeks, or a month, before purchasing the product or service. This lag characteristics can be modeled by the following equation 1:

$${( {x}_{t} )}_{l} = \{ \begin{matrix}0 , & ( 1 \leq t \leq a ) \\ {x}_{t - α} , & ( t > α )\end{matrix} \qquad ( 1 )$$

Equation 1 illustrates lag transformation where a is the lag period, xₜ is the promotional spend at time period t and (xₜ)ₗ is the lagged promotional spend at time period t. Said another away, a is the amount of time between when a consumer views the advertisement to a time when the consumer purchases the product or service promoted by the particular advertisement. The value xₜ is the amount spent on the product or service promoted by the particular advertisement at a time period t. Equation 1 shifts the data points by alpha time-steps while making first alpha values set to zero.

Adstock can be described as the effects of advertising that does not perfectly align with advertising movements, but rather, describes delayed and spread out advertising effects overtime. Advertising adstock is a term used for measuring this memory effect or carryover effect over time. Specifically, adstock is a model of how responses to advertising builds and decays in consumer markets. Advertising tries to expand consumption of a service or product in two ways, by reminding and teaching. For example, advertising reminds in-the-market consumers in order to influence their immediate brand choice and teaches to increase brand awareness and salience, making it easier for future advertising to influence brand choice. Adstock is the mathematical representation of this behavioral process. Adstock can be modeled by the following equation 2:

(xₜ)_{d}=β*(xₜ)ₗ+(1−β)*(xₜ₋₁)_{d} (2)

Equation 2 illustrates adstock transformation where (xₜ)ₗ is the lagged promotional spending for the service or product at time period t obtained from Equation 1, (xₜ₋₁)_{d} is the adstock promotional spend at time period t−1, and β is the adstock parameter which can be any value between 0 and 1 while making first (xₜ₋₁)_{d} values set to zero

Fractional root can be described as marketing activity which will cause diminishing rates of return as total spending increases. Every additional dollar spent generates fewer returns than the previous dollar. The usual approach to account for saturation is to transform the advertising variable to a non-linear scale for example log or negative exponential transformations. The fractional transformation can be modeled by the following formula:

(xₜ)_{ƒ}=(xₜ)_{d}^{γ} (3)

Equation 3 illustrates fractional root transformations. In equation 3, (xₜ)_{d} is the adstock promotional spend at time period t, (xₜ)_{ƒ} is the promotional spend amount after fractional transformation and gamma γ is the fractional root factor.

In some implementations, the system 100 can combine the promotional characteristics transformations to be able to generate a model for determining the optimum promotions for a particular sale. For example, in order to combine the lag, decaying, and saturation effects, the system 100 can first apply the lag transformation to a time series of media spending, and then apply the adstock transformation and finally the fractional root transformation. The resultant transformation variable is then utilized in the sales response model for the modeling process. For example, consider weekly promotional data in a situation where the selling of a shoe has a spending xₜ at time period t (refer to below table). In this example, consider a user sees an advertisement on January 1, but then buys the shoe 2 weeks later, on January 14, so α would be 2, for 2 weeks as it is weekly data. Equation 1 shifts the data points by 2 time-steps while making the first 2 values set to zero in the column (xₜ)ₗ in the first step. β is the adstock parameter, which can take any value between 0 and 1. In this example, let's say β is 0.4 value. For example, the (x₃)_{d} is calculated using equation 2 as below.

(x₃)_{d}=β*(x₃)ₗ+(1−β)*(x₂)_{d}=0.4*6+0.6*0=2.4

Similarly, other (xₜ)_{d} values are calculated using Equation 2 in the second step. γ is the fractional root factor, which is any value between 0 and 1. In this example, let's say γ is 0.8 value. For example, the (x₃)_{ƒ} is calculated using equation 3 as below.

(x₃)_{ƒ}=(x₃)_{d}^{0.8}=2.4^{0.8}=2.0145

Similarly, other (xₜ)_{ƒ} values are calculated using Equation 3 in the third step and shown in the table below.

| week(t) | Xt | (Xt)l | (Xt)d | (Xt)f |
|---|---|---|---|---|
| 1 | 6 | 0 | 0 | 0 |
| 2 | 4.4 | 0 | 0 | 0 |
| 3 | 4.8 | 6 | 2.4 | 2.014508 |
| 4 | 2 | 4.4 | 3.2 | 2.535829 |
| 5 | 5.4 | 4.8 | 3.84 | 2.934033 |
| 6 | 7.6 | 2 | 3.104 | 2.474784 |
| 7 | 4.2 | 5.4 | 4.0224 | 3.045006 |
| 8 | 3.2 | 7.6 | 5.45344 | 3.884512 |
| 9 | 3.9 | 4.2 | 4.952064 | 3.596077 |
| 10 | 1 | 3.2 | 4.251238 | 3.182822 |
| 11 | 1.2 | 3.9 | 4.110743 | 3.098391 |
| 12 | 10 | 1 | 2.866446 | 2.322068 |

In particular, the modeling server 102 includes an action planner that performs the processing of generating the model. The action planner manages building the models, running simulations of the models, and traversing through the models based on Q-value functions and reinforcement learning processes. The action planner can be a software module that employs various functions for executing different functions.

During stage (C), the action planner of the modeling server 102 generates a transformation space based on a promotional channel. In some implementations, the action planner generates a transformation space for each promotional channel for a particular sale opportunity. The promotional channels are the available promotional channels provided by the user 104 during stage (A).

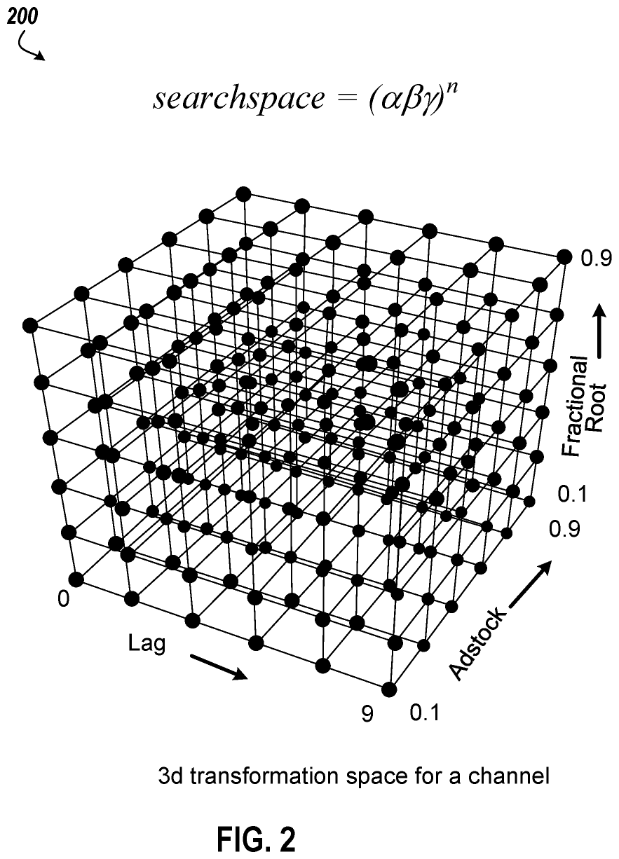

In some implementations, the action planner generates a transformation space based on a range of numbers for characteristics of a promotional channel. For example, as illustrated in FIG. 2, which is an example of a transformation space 200 generated by the system, the action planner generates an N-dimensional transformation space for each promotion channel that holds values for each of alpha α, beta β, and gamma γ. These values can range from any sets of numbers, but are typically determined by the inputs from user 104 or automatically determined from prior simulations. Equation 1 includes the alpha α being modeled in the transformation space 200. Equation 2 includes the beta β being modeled in the transformation space 200. Equation 3 includes the gamma γ being modeled in the transformation space 200.

As shown in the transformation space 200, alpha α, which corresponds to the lag on the X-axis, varies from 0 to 9. Beta J, which corresponds to the adstock on the Y-axis, varies from 0.1 to 0.9. Gamma γ, which corresponds to the fractional root on the Z-axis, varies from 0.1 to 0.9. Alternatively, the transformation space 200 may include more than or less than three variables and can include number ranges for each of the variables different from those illustrated in FIG. 2. Here, alpha, beta, and gamma can take on any of 10 values, although those numbers or number ranges may vary. The number of possible models can be calculated using a search space equation 4 shown below.

searchspace:(αβγ)ⁿ (4)

Equation 4 can illustrate the number of models to be calculated using the defined variables. The variable n, in equation 4, is the number of promotional channels. These promotion channels can include, for example, web advertisements, commercials on television, brochures, emails, advertisements on social media, and word of mouth advertisements, to name a few examples. For example, the action planner can generate eight transformation spaces, each transformation space representative of a promotional channel in the modeling process, e.g., n=8. In this manner and as will be described below, the action planner and corresponding agents can execute simulations for the eight transformation spaces.

During stage (D), the action planner can execute simulations for each of the generated transformation spaces. Continuing with the example from above, the action planner can generate eight transformation spaces, each transformation space representative of a particular promotional channel. Each promotional channel is required to undergo lag, adstock, and fractional root transformation. In the case of eight transformation spaces, 1000⁸ transformations are possible, e.g., (10*10*10)⁸=(1000)⁸. Consequently, the total number of model combinations possible is 10²⁴. If the action planner were to test iteratively each value for each transformation space in a linear exhaustive search, and one model building takes 1 millisecond (ms), then the action planner would require approximately 10¹³ years to determine an optimal set of parameters from the eight transformation spaces. In order to find a set of optimal solutions, the action planner may not be able to perform exhaustive search over a large space in a practical time. Further, the complexity of the modeling increases with a number of transformations performed and a number of promotional channels, which makes this optimization process computationally expensive to solve. In general, the promotion optimization problem formulation has a nonlinear objective curve and is non-deterministic polynomial-time (NP)-hard. NP-hard is a defining property of a class of problems that are at least as hard as the hardest problems in NP. NP is a complexity class of problems that is used to classify decision problems.

In some implementations, the action planner utilizes reinforcement learning (RL) to determine optimum promotional parameters for a particular sale. RL is concerned with how intelligent agents or processors take actions in an environment in order to maximize a cumulative reward. For a given state, an agent, e.g., the action planner, takes an action based on the current state of the transformation space. In response to that action at that state, the generate will receive a reward from the environment, and the current state is then changed to the next state.

Additionally, the action planner utilizes multi-arm bandit algorithms that take decisions in uncertainty. The modeling server 102 models in a way that each promotional channel represents one slot machine or bandit, where each slot machine has three controlling parameters, e.g., the three controlling parameters being lag, adstock, and fractional root. The combination of transformation parameters represents the state of each environment for a particular transformation space. Similarly, this may be analogous to actions taken by an animal instinct to explore the environment but also to explore in a manner that maintains certain parameters, e.g., rewards and/or behavior. Here, one action planner orchestrates an environment for each of the transformation space. The action planner utilizes a set of agents (Δᵢ) that execute exploring a corresponding environment through a transformation space. An agent is a software based entity in this setup which acts based on the inputs given by the action planner serving as a virtual AI engine. For example, system 100 includes Agent 1, Agent 2, through Agent N.

The agent for each environment initiates an action for each transformation space while keeping the other transformation spaces stable. After the agent executes an action for a transformation space, e.g., identifying values from a transformation space and calculating values from equations 1-3, the action planner computes a reward for the transformation space considering both extrinsic and intrinsic factors, as will be further described below.

The action planner iterates this reward process in a game based framework to select a right combination of promotional transformation parameters to arrive at a model which satisfies the user 104's business criteria objectives. The action planner executes a process using principles of model free temporal difference (TD) reinforcement learning (RL), where the action planner ultimately learns and adapts to an optimal policy by exploiting and exploring the states from each environment.

Based on the discussion above, the action planner implements the following processes, which will be further elaborated on below. First, the action planner orchestrates the agents for each of the environments or channels. In particular, each environment is assigned a transformation space. The dimensions of the transformation space are set according to degrees of freedom available for transformations, e.g., the degrees of freedom correspond to the lag, adstock, and fractional root characteristics of a promotion. The degrees of freedom are also equivalent to a gambler pulling the arm of a slot machine in N-dimensional space, and not knowing the result.

Then, the action planner chooses the random state for each environment. The random state for each environment is the initial states from which agents can make transitions to the next state. The state of each environment corresponds to the transformation parameter combination for each channel in the transformation space. For example, the state of the channel 1/bandit 1 can include (1, 0.2, 0.1) for (α, β, γ). Other values are also possible for the initial random state.

The action planner can choose the random state for each environment initially to ensure that the agent for each environment has sufficient exploration of the corresponding transformation space. Then, the action planner chooses actions from an available set of actions by referring to a Q-table 110, and then the agents for each corresponding environment make a transition from one state to another state in each environment based on the provided actions from the action planner. This movement from one state to another state is equivalent to a gambler pulling a random arm of slot machines initially to play in a sequence of trials to maximize the reward. For example, if the channel 1/bandit 1 has a state of (1, 0.2, 0.1), and agent for the channel 1/bandit 1 can transition the channel 1/bandit 1 to a new state of (2, 0.2, 0.1), by incrementing the alpha value.

In some implementations, the action planner executes a model by combining the states of all the environments once each agent has transitioned each of the transformation spaces. The state of each environment or transformation space corresponds to the transformation parameter combination (alpha α, beta β, gamma γ). Then, the action planner evaluates the combined model by calculating model metrics like volume contribution, p-value, R², DW, and mean absolute percentage error (MAPE), to name a few examples. In some implementations, sales from MMM are divided into two components—Base Sales and Incremental Sales. Base Sales corresponds to marketers returns if they do not perform any advertisements. Incremental Sales corresponds to sales generated by marketing activities. Volume contribution from each promotional channel is product of its beta coefficient in regression model and marketing spent value. The p-value is a probability score that is used in statistical tests to establish the statistical significance of an observed effect. The predictor that has a low p-value is likely to be a meaningful addition to your model because changes in the predictor's value are related to changes in the response variable. R2 is a statistical measure that represents the goodness of fit of a regression model. The Durbin Watson (DW) statistic is a test for autocorrelation in the residuals from a statistical model. The mean absolute percentage error (MAPE) is a measure of prediction accuracy.

The action planner compares each of the calculated model metrics to threshold values. The threshold values are defined and provided by the user during stage (B). As such, the objective is to achieve the threshold for each metric termed as a business objective. The business objective can be quantified using proposed entropy equations. In some implementations, the action planner can calculate a distance metric for each evaluated metric and can normalize the distance metric with respect to threshold values. Afterward, the action planner can calculate an entropy of the generated model using a normalized ratio calculation. Entropy is calculated at each state in the entire process.

The action planner observes the current state of the model and can choose actions for each agent in order to make a transition to the next state of a model, in such a way that the maximum cumulative reward is obtained. The action planner refers to a Q-value of a state action pair of each environment at every state and the action planner selections actions to take based on varying policies. For example, the action planner may select a state based on an epsilon greedy policy or another brute force method type policy. Based on the action planner's selected action from the Q-table 110, the action planner provides the selected action to each agent, and each agent makes a transition to the next state in their respective environment. Afterwards, the action planner calculates the entropy for the next state.

The action planner then calculates the reward based on the entropy in the current state and the next state. The action planner updates the Q-value in the Q-table 110 for a corresponding state action pair. The entropy points indirectly create the response surface which helps the action planner to choose the next set of actions. Ultimately, the objective of the action planner is to achieve a state with zero entropy. This process continues until at least a predefined number of steps. If the action planner ever observes a state of zero entropy for a particular model in any intermedia state of the algorithm, then the action planner terminates the algorithm and outputs the latest generated model.

During stage (E), after the action planner has initialized the states for each of the agents and the agent has transitioned the state for its corresponding transformation spaces from the initial state to a second state, the action planner generates a model. For example, the action planner generates a model by identifying the states from each of the environments. One example of such a model can be shown in the following equation:

model=[Channel 1:(α₁,β₁,γ₁),Channel 2:(α₂,β₂,γ₂), . . . Channel N(α_{N},β_{N},γ_{N})] (5)

As previously mentioned, the states from each environment or promotional channel are combined, as illustrated in equation 5.

During stage (F), the action planner performs an evaluation on the model. For instance, the process performed by the action planner at this point specifies a parametrized sales function as illustrated below in equation 6:

yₜ=F(x_{1,m}. . . x_{T,m};ϕ) (6)

In equation 6, yₜ represents the sales of the sale opportunity at time t, F( . . . ) represents a regression function, xₜ=(x_{t,m}; m=1, . . . , M; t=1, . . . , T) is a vector of promotional variables M at time t, and ϕ is the vector of parameters in the model.

In some implementations, the action planner can determine metrics corresponding to the generated model. The metrics can include beta coefficient metrics, volume contribution metrics, p-value metrics, and R2eff metrics, to name a few examples.

During stage (G), the action planner calculates a distance function metric for each of the generated metrics from stage (F). The distance function metric is measured by equation 7 shown below:

$$f ( x ) = \{ \begin{matrix}{C}_{i} - {C}_{i} * \frac{2}{π} * {tan}^{- 1} ( {d}_{i} * ( {e}_{i} - {x}_{i} ) ) , & {x}_{i} < {e}_{i} \\ {C}_{i} , & {x}_{i} \geq {e}_{i}\end{matrix} \qquad ( 7 )$$

Equation 7 illustrates a distance function metric that can be used to calculate a business objective deviation. For instance, eᵢ is an optimum value for a given business objective and Cᵢ is a pre-defined constant/threshold used to evaluate the deviation from the business objective corresponding to the sales opportunity. The function ƒ(xᵢ) can take on any value between 0 to Cᵢ and the function can quantify the deviation or breadth of the business objective from the predefined/expected threshold. In equation 7, eᵢ=expected threshold of respective model metric, dᵢ=constant to regulate the function value with respect to change in model metrics, and the variable i corresponds to the i^{th} environment with multiple environments, such as environment 1 through environment 8.

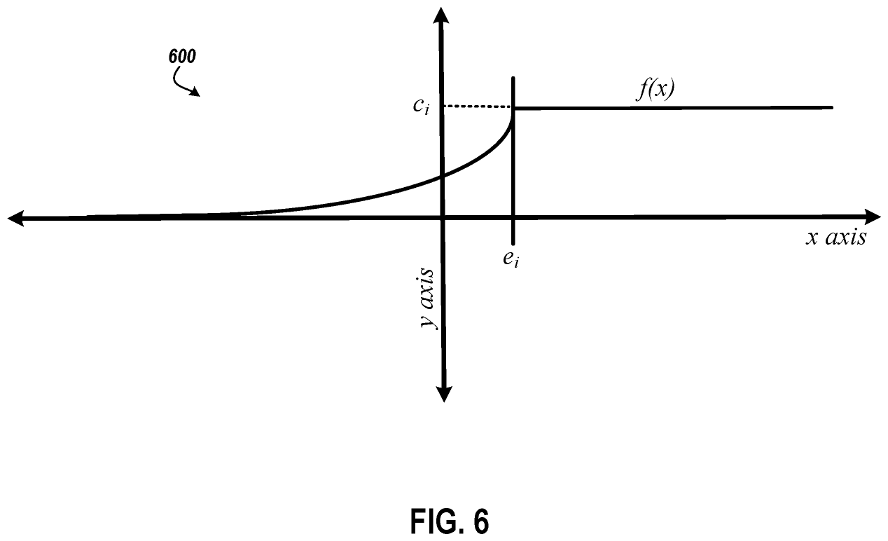

FIG. 6 is a graphical representation that illustrates a score for each channel corresponding to a business condition. In particular, FIG. 6's graphical representation illustrates a graphical form of equation 7. The graphical form shows the predefined threshold used for evaluating the business decision, e.g., Cᵢ, and the function ƒ(xᵢ) can take on any value between 0 and Cᵢ, and the value of ƒ(xᵢ) becomes Cᵢ when the input of ƒ(xᵢ) becomes eᵢ.

Returning back to FIG. 1A, during stage (H), the action planner computes a summation for each of the predefined thresholds, e.g., Cᵢ. The summation for each of the predefined thresholds is computed using the following equation 8:

Total Score=Σᵢ₌₁^{b}Cᵢ (8)

In equation 8, the action planner performs the summation of all the predefined thresholds (CL) for business objectives and identifies the calculated Total Score. Then, in equation 9, the action planner adds the individual score for each stage and normalizes the score with the total score for attaining the ratio P. The value P will be used in the entropy equation as illustrated below. For instance:

$$P = {\sum }_{i = 1}^{n} \frac{f ( {x}_{i} )}{Total Score} \qquad ( 9 )$$

During stage (I), the action planner can determine entropy values for the corresponding model. The action planner's objective is to quantify a model output with a single number that indicates how much of a corresponding business objective for a promotion is satisfied by the model. In particular, there are multiple business objective metrics attached to the model, such as volume contribution, p value, beta coefficient, total volume contribution of all channels, and others, to name a few examples. The action planner relies on an entropy based mathematical equation to quantify the various parameters of a corresponding model. The farther the model output from the desired objective, the higher the entropy of the corresponding model. Alternatively, the closer the model output from the desired objective, the lower the entropy of the corresponding model.

By calculating the entropy of the model, the action planner can model and quantify the chaos or uncertainty in the model arising because of the transformation parameters. Ideally, the task is to define an entropy-based equation which models the existing uncertainty in terms of achieving the business objectives. Thus, the action planner seeks to maximize the business condition value, in turn minimizing the entropy in the model. As illustrated in equation 10 below, P corresponds to the normalized ratio attributing to the percentage attainment of the business objective. For example, P=1 means the business objectives have each been achieved and P=0 means the business objective values are a large distance away from the expected value or defined threshold, resulting in highest entropy possible. Entropy H is calculated in equation 10 below:

$$H = \{ \begin{matrix}2 , & p = 0 \\ 2 + p * {log}_{2} p + ( 1 - p ) * {log}_{2} ( 1 - p ) , & 0 < p \leq 0.5 \\ - p * {log}_{2} p + - ( 1 - p ) * {log}_{2} ( 1 - p ) , & 0.5 < p < 1 \\ 0 & p = 1\end{matrix} \qquad ( 10 )$$

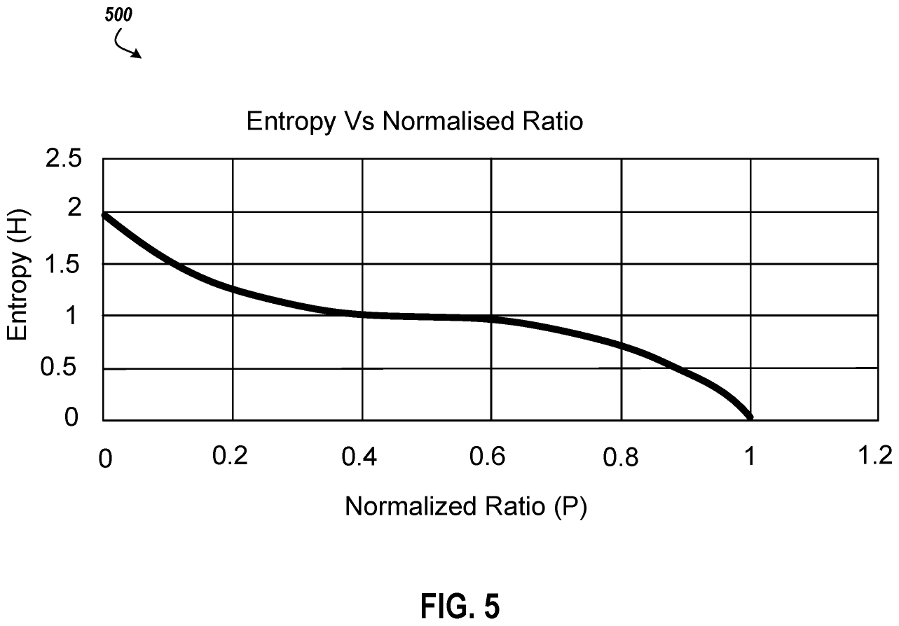

FIG. 5 is a graphical representation that illustrates a relationship between entropy and a normalized ratio, as defined by equation 10. For example, as the normalized ratio P approaches 0, the entropy value approaches the number 2. As the normalized ratio P approaches the value 1, the entropy value approaches the number 0.

In some implementations, the action planner can calculate entropy with the normalized ratio determined from stage (H). The normalized ratio corresponds to how much value is obtained out of total is required or can be achieved for a potential business objective. Thus, the action planner had to obtain the model metrics, e.g., volume contribution, beta coefficient, R2, and p-value, to name a few examples. In one example, volume contribution may be 20% for a corresponding promotional channel. The actual volume contribution in the model is 10%. Thus, the normalized ratio for an entropy calculation becomes P=10/20=0.5, and the corresponding entropy will be 1. This can be possible when the values of volume contribution are non-negative. However, in reality, volume contribution can be negative and as such, normalized ratio cannot be calculated in this way for negative values.

In another example, an important requirement during this process is that the beta coefficient remains positive. In this case, the normalized ratio cannot be calculated in a normal way as the numerator values are negative often in actual models and the denominator value cannot be decided unless an actual beta coefficient value is met.

Thus, from the above the examples, it is difficult for the action planner to calculate the normalized ratio in a general way. Thus, a fixed benchmark value must be determined for the denominator. Additionally, the numerator value corresponding to the actual metric value should be scaled with respect to a different with the benchmark value. This is why equation 7 includes a distance function metric, which ensures the normalized ratio calculation is generic to all metrics. By incorporating the distance function metric in the normalized ratio calculating, the entropy calculation can aid in segregating the good and bad transformation space states and can quantify the distance of a given state from a possible optimum model solution. Quantification of the distance will aid in improving the path to reach an optimal model when calculating the entropy values for the model.

In some implementations, the action planner can compare the generated entropy H to a threshold value. If the entropy H equals 0, then the action planner exits the iterated loop and outputs the model, represented by equation 5, to the client device 106. Otherwise, the action planner continues to perform the different processes for each iteration.

During stage (J), the action planner calculates a proposed reward policy based on entropy, which takes into account both intrinsic and extrinsic gain. The intrinsic factors consist of metrics of the environment in which action is performed, e.g., volume contribution, beta coefficient, and p-values. The extrinsic factor include metrics of other channels include model metrics, e.g., R2 efficiency, total volume contribution, and others. The proposed reward policy is calculated using the following equation 11:

$${R}_{t + 1} = \frac{{K}_{1} * Δ H}{{K}_{3} + {K}_{2} * {H}_{t + 1}} \qquad ( 11 )$$

Each agent of a particular environment is rewarded by the action planner for the quality of the move or action taken in the given state to a next state. The reward is calculated for a transition from state Sₜ to state Sₜ₊₁ by taking action at. The higher the entropy for the transitioned state, the larger the uncertainty and the lesser the reward for the action. Therefore, reward is inversely proportional with absolute entropy (Hₜ₊₁). More reduction in entropy (ΔH=Hₜ−Hₜ₊₁) means the greater the action and the greater the reward. Thus, the reduction in entropy for a transition between states is directly proportional to the reward. The reward is calculated using equation 11 above.

In equation 11, Hₜ₊₁ is the entropy corresponding to the new state of (Sₜ+1). AH is the difference of the entropy between two states Sₜ and Sₜ₊₁. K₁ is the constant used to regularize the ΔH, K₂ is the constant used to regularize the entropy of the state. K₃ is a constant.

For the case where the entropy of a new state (Hₜ₊₁) approaches to zero, the action planner calculates a reward value that tends to infinity, which is mathematically inconsistent. To account for the condition where the reward value tends to infinity, the denominator of the reward function is adjusted by a constant K₃, e.g., K₃=1, as shown in equation 11. Achieving the entropy zero means that all business objectives for promotions have been satisfied, and the agent is given a full maximum reward for the transition between states, meeting an optimum solution for traversing the transformation space. In equation 11, Hₜ₊₁ and ΔH are absolute values of entropy, and hence their impact on reward function has to be regularized at both ends. For this reason, the entropy K₁ alongside ΔH to control the impact of the reward function and K₂ alongside ΔHₜ₊₁, in the denominator to avoid any inconsistent on the reward.

During stage (K), the action planner stores the change of states for each agent and the corresponding reward for the transition between states. In this manner, the action planner can track the movements of each agent through their respective transformation spaces based on a corresponding reward policy. The action planner stores the previous actions for each agent.

During stage (L), the action planner can select future actions for each agent in the next iteration. A future action can correspond to a direction of adjusting either one or more of the alpha α, beta β, or gamma γ values for a particular transformation space by one unit. For example, the action planner can determine that over the past 10 actions made by a particular agent, by increasing the alpha α value for a particular transformation space, the agent has generated the greatest reward, and ultimately, decreased the entropy value. Thus, in this example, that agent should continue increasing the alpha a value until the entropy value starts to increase, at which point the agent can start to manipulate the beta β and gamma γ values to try and identify the combination of alpha, beta, and gamma values that provide the lowest entropy, and the corresponding highest reward. Alternatively, the action planner can provide a variety of actions for each agent to take, and the agent can decide independently which action to take for state transitions.

The process of stages (D) through (L) repeats until an entropy of zero is reached for a particular model or a predefined number of iterations have been met. In response to the process completing, the modeling server 102 distributes the final model to the client device 106. With the final model, the user 104 can analyze characteristics of promotions for a corresponding sale based on the generated model. The model can identify types of effects certain promotions will have on a particular sale, with regards to lag, adstock, and fractional root characteristics.

To contextualize the above description, it is helpful to analyze a mathematical example of a reward function. For example, system 100 models two promotional channels for a particular sales activity, e.g., a digital television promotion and a traditional brochure promotion. In this example, the digital channel actual volume contribution is −2% (xᵢ=−2), p-value of 0.5, and beta coefficient of −250 in the model in the intermediate step. The volume contribution is expected to be 8% (eᵢ=8), p-value of 0.3 (e₂) and positive beta coefficient (e₃=0) is expected. Consider a predefined threshold of the following (C₁)₁=200, (C₂)₁=100, (C₃)₁=200, and constant d₁=0.05, d₂=2, d₃=0.001.

With these values for the digital promotional channel, the corresponding distance metrics using equation 7 can be evaluated. For example:

$${f ( {x}_{1} )}_{1} = 200 - 200 * \frac{2}{π} * {tan}^{- 1} ( 0.05 * ( 8 - ( - 2 ) ) ) = 140.96 \qquad ( 12 )$$

$${f ( {x}_{2} )}_{1} = 100 - 100 * \frac{2}{π} * {tan}^{- 1} ( 2 * ( - 0.3 + 0.5 ) ) = 75.77 \qquad ( 13 )$$

$${f ( {x}_{3} )}_{1} = 200 - 200 * \frac{2}{π} * {tan}^{- 1} ( 0.001 * ( 0 - ( - 250 ) ) ) = 168.8 \qquad ( ! 4 )$$

Continuing with this example, traditional brochure promotion, the traditional channel actual volume contribution is 3% (xᵢ=3%), p-value of 0.35, and beta coefficient of 350 in the model in the intermediate step. The volume contribution is expected to be 8% (eᵢ=8), p-value of 0.3 (e₂) and positive beta coefficient (e₃=0) is expected. Consider a predefined threshold of the following (C₁)₂=200, (C₂)₂=100, (C₃)₂=200, and constant d₁=0.05, d₂=2, d₃=0.001.

With these values for the traditional brochure promotion, the corresponding distance metrics using equation 7 can be evaluated. For example:

$${f ( {x}_{1} )}_{2} = 200 - 200 * \frac{2}{π} * {tan}^{- 1} ( 0.05 * ( 8 - 3 ) ) = 168.8 \qquad ( 15 )$$

$${f ( {x}_{2} )}_{2} = 100 - 100 * \frac{2}{π} * {tan}^{- 1} ( 2 * ( - 0.3 + 0.35 ) ) = 93.65 \qquad ( 16 )$$

$${f ( {x}_{3} )}_{2} = 200 \qquad ( 17 )$$

Once the distance metrics have been calculated for the traditional brochure promotional channel and the digital promotional channel, the normalized ratio and the proposed entropy equations can then be calculated. For example:

$$totalscore = {( {C}_{1} )}_{1} + {( {C}_{2} )}_{1} + {( {C}_{3} )}_{1} + {( {C}_{1} )}_{2} + {( {C}_{2} )}_{2} + {( {C}_{3} )}_{2} = 1000 \qquad ( 18 )$$

$$P = \frac{( ( {f ( {x}_{1} )}_{1} + {f ( {x}_{2} )}_{1} + {f ( {x}_{3} )}_{1} + {f ( {x}_{1} )}_{2} + {f ( {x}_{2} )}_{2} + {f ( {x}_{3} )}_{2} )}{totalscore} = 0.847 \qquad ( 19 )$$

$$H = - 0.847 * log ( 0.847 ) - 0.153 * log ( 0.153 ) = 0.1858 \qquad ( 20 )$$

Equations 12 through 14 and equations 12 through 17 exhibit the distance metric values for the digital channel model and the distance metric values for the traditional channel model, respectively. Then, the normalized ratio scores are calculated in equations 18 and 19. Following the determination of the normalized ratio scores, the proposed entropy is calculated in equation 20. Because the value of P falls within the range of 0.5<P<1, as defined by equation 19, then the bottom equation from equation 10 is used by the action planner for calculating the entropy in equation 20. Once the entropy has been calculated, the action planner can employ a variety of methods to calculate a proposed reward policy. For example, the action planner can employ a Q-Learning (Off-policy), which will be further described below.

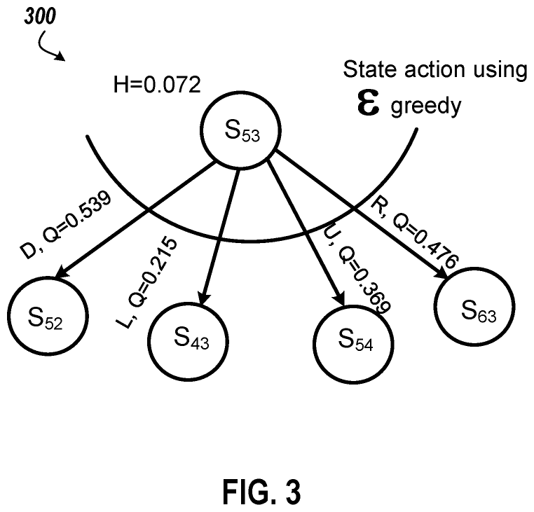

FIG. 3 is an example of a state transition for a transformation space using an epsilon greedy policy. FIG. 3 illustrates a state S₅₃ and four different states for the agent to transition to next. These states include S₅₂, S₄₃, S₅₄, and S₆₃. The movement to each of those states by the agent creates different Q values. For example, if the agent transitions from S₅₃ to S₅₂ in a downward movement (D), the Q value is 0.539. If the agent transitions from S₅₃ to S₄₃ in a leftward movement (L), the Q value is 0.215. If the agent transitions from S₅₃ to S₅₄ in an upward movement (U), the Q value is 0.369. If the agent transitions from S₅₃ to S₆₃ in a rightward movement (R), the Q value is 0.476. According to FIG. 3, the agent can choose the movement to S₆₃ because it results to the highest Q value. The movements can be based on the epsilon greedy policy, for example.

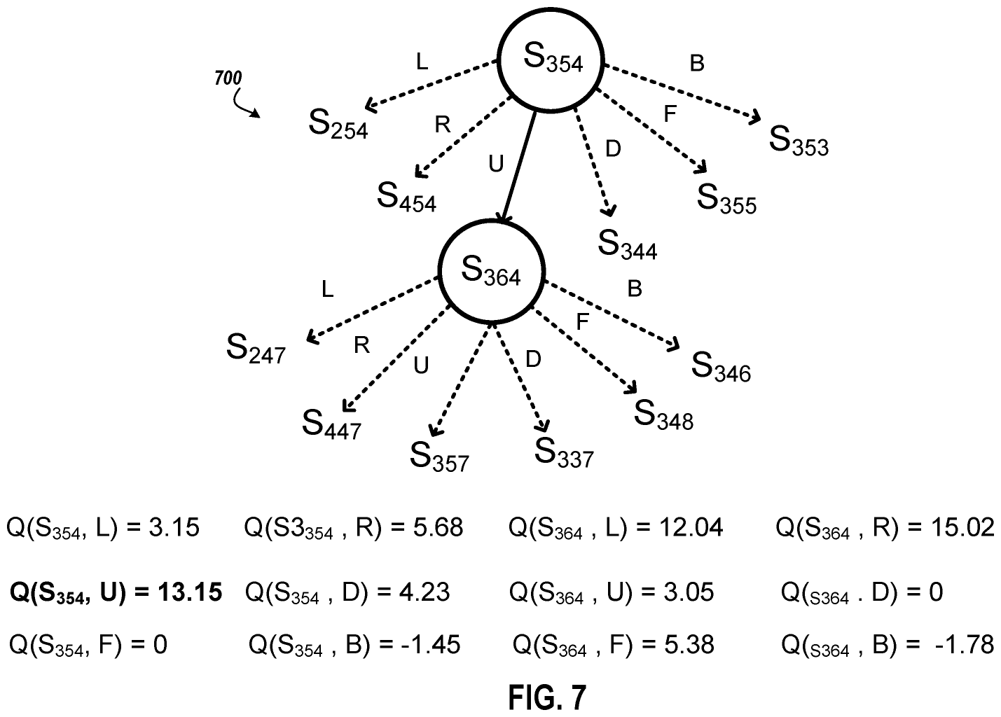

FIG. 7 illustrates a transition between states based on Temporal Difference Q-learning (off-policy) for calculating a reward between state transitions. As shown in FIG. 7, assume a transition happens in the digital channel promotion between states. The current state Sₜ of channel 1 is S₃₅₄, in this example. The following constants are set for this situation: E=0.2, learning rate α=0.2, and discount factor γ=0.9. FIG. 7 illustrates two states, S₃₅₄ and S₃₆₄. The agent can take various movements from S₃₅₄. The movements can include left (L), right (R), up (U), down (D), forward (F), and backward (B). These movements describe movements of the agent through their respective transformation space in three or more dimensions. A change in state changes the alpha α, beta β, and gamma γ parameters for a particular promotional channel.

In some implementations, the algorithm for the reward policy follows a particular policy. That policy can be an epsilon greedy policy, or some other policy. In the current state, the action generates a random number of 0.6, and the algorithm selects the action which has a maximum Q-value and transition to new state Sₜ₊₁, which is S₃₆₄ by taking action U or up. Here, up (U) action (at) is taken by the algorithm, as it has a maximum Q-value, i.e., Q(S₃₅₄, U)=13.15. The reward Rₜ₊₁ for transition from state S₃₅₄ to S₃₆₄ is 42.9, using equation 11. Now, the Q-value of current state S₃₅₄ and U action is to be updated using Q learning update equation 21. For example:

$$Q ( {S}_{t} , {A}_{t} ) ← Q ( {S}_{t} , {A}_{t} ) + α * [ {R}_{t + 1} + γ * ( {max}_{A} Q ( {S}_{t + 1} , {A}_{t + 1} ) ) - Q ( {S}_{t} , {A}_{t} ) ] \qquad ( 21 )$$

The maximum Q value of state S₃₆₄ is 14.02 corresponding to action R.

Q(S₃₅₄,U)←Q(S₃₅₄,U)+α*[Rₜ₊₁+γ*Q(S₃₆₄,R)−Q(S₃₅₄,U)] (22)

Q(S₃₅₄,U)←13.15+0.2*[42.9+0.9*15.02−13.15]=21.8 (23)

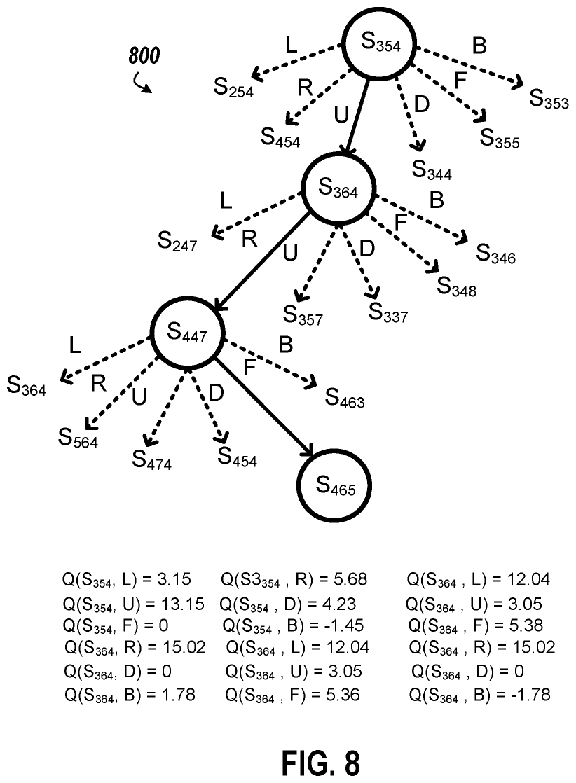

FIG. 8 is a graphical representation that illustrates a transition between states based on an N-step SARSA policy. As shown in FIG. 8, assume a transition happens in the digital channel promotion between states. The current state Sₜ of channel 1 is S₃₅₄, in this example. The following constants are set for this situation: E=0.2, learning rate α=0.2, and discount factor γ=0.9. FIG. 8 illustrates four states, S₃₅₄, S₃₆₄, S₄₄₇, and S₄₆₅, in which the agent can take various movements through each of the states.

FIG. 1B is a block diagram that illustrates an example of a system 101 for generating a model based on reinforcement learning and marketing mix modeling processes consisting of algorithmic and technological framework. System 101 includes similar components and similar functionality as system 100. For example, system 101 includes one or more client devices 106-1 through 106-N that communicate with the modeling server 102. As similarly performed in system 100, the user 104 configuring with one or more of the client devices 106-1 through 106-N can provide data 108 representative of the business objectives and promotional channel to the client device(s). In response, the client device(s) can transmit the data 108 to the modeling server 102 over a network.

In some cases, the user 104 may provide multiple sets of data 108 to each client device, such that the modeling server 102 can generate models using various promotional channels. For example, the user 104 can provide client device 106-1 with only digital promotional data for the corresponding sale opportunity, can provide client device 106-2 with only traditional promotional data for the corresponding sales opportunity, and can provide client device 106-N with hardcopy promotional data for the corresponding sales opportunity. In this manner, each client device can instruct the modeling server 102 to generate a model for each respective promotional data type. Alternatively, the user can provide a single client device 106-1 with each of digital, traditional, and hardcopy promotional data, such that the modeling server 102 generates a model that collectively model each of the promotional data types.

The modeling server 102 executes a training module process 103 for identifying the optimum states using the transformation spaces. Initially, the modeling server 102 sets a training signal 116 that is randomly established. The training signal can be initial values for the alpha α, beta β, and gamma γ combination that enables agents to traverse through the transformation space 122. The training signal value is also stored in the last action, where the Q-table 110 stores state changes and reward values for the state changes. Similar to system 100, the agent for the transformation space 122 adjusts the initial state to a new state, and the action planner for the modeling server 102 calculates metrics 120 for the adjustment. The metrics 120 include, for example, proposed distance metrics, the normalized ratio values, entropy values, and a corresponding proposed reward value. In response, the action planner stores the newly update state changes and the corresponding reward value in the Q-table for tracking purposes. The agent can then select the next state change, and the process iterates.

In some implementations, the modeling server 102 implements a policy control 126 during the iterations. The policy control 126 can include the type of policy, such as an epsilon greedy policy or another type of policy. Additionally, the policy control 126 can indicate the type of reinforcement learning policy for the action planner to utilize. For example, the type of reinforcement learning policy can include a Q Learning policy or some other policy.

In some implementations, the modeling server 102 can build a recursively trained neural network system using the optimization with the transformation spaces. The recursively trained neural network model can be used to produce likelihoods of promotional uses, produces estimates of Q values, and produce estimates of entropy values, to name a few examples. The modeling server 102 can, in some examples, use a genetic algorithm partial least square analyses to acquire the optimum subset of promotional spend variables based on cross-validated correlation coefficient q2 (similar to R2), that would server as the initial inputs for the neural network, which is trained with the selected variables, e.g., recursively trained neural network model. The neural networks that are guided by the genetic algorithm-partial least squares is able to provide external users to the modeling server 102 with a better understanding of how promotional activities affect a particular sales opportunity.

The actions taken by set of agents 124 transition the transformation space 122 to new state. To calculate the reward for the transition, the models corresponding to new state is required to be built along with performing entropy, reward, and Q-value calculations. For example, the Lambda serverless architecture 130 performs the model building and other calculations required to update the Q-value table. The serverless architecture 130 also needs to queue events and based on the state of the queues and arrival rate of events, schedule the execution of functions, and manage stopping and deallocating resources for idle function instances. In another example, Ray Clustering 128 can be used, which is a fast, simple distributed execution framework that makes it easy to scale and trigger multiple lambdas for modeling and calculations. The process performs until a final model 114 is generated.

FIGS. 1C and 1D are block diagrams that illustrate an example of flow charts for implementing training a model using reinforcement learning (Temporal Difference Q-leaning), uncertainty reduction principles, response surface methodologies and marketing mix modeling. FIG. 1C continues into FIG. 1D. In particular, FIGS. 1C and 1D illustrate the training module process 103 for identifying the optimum states using the transformation spaces. The modeling server 102 can perform the process 103. Additionally, the process 103 performed in FIGS. 1C and 1D are similar to processes performed in systems 100 and 101 from FIGS. 1A and 1B. FIGS. 1C and 1D illustrate various operations in stages (A) though (D) which may be performed in the sequence indicated or another sequence.

In some implementations, the processing module 103 iterates over the N different transformation spaces to identify the set of optimum states for a model. FIG. 1C illustrates a two-dimensional view 136 of a transformation space, such as transformation space 138-1. Each state of a transformation space can be defined by one or more particular promotional values, and these values can include, for example, adstock, lag, and fractional root values. For example, the two-dimensional view 136 illustrates four states that include the values of 0.215, 0.369, 0.766, and 0.549. These values are based on the ranges of values set for the promotional characteristics of the transformation space. However, as previously described, a transformation space can range from 1 to N dimensions.

During stage (A), the action planner choses a random state for each transformation space or channel. For example, process 103 includes generating a number of transformation spaces or channels based on the number of promotions for a particular sale opportunity. The action planner selects a random initial state for each of the transformation spaces, e.g., transformation spaces 138-1, 138-2, and 138-N. The state of each transformation space in a particular environment is indicative of the transformation parameter combination. For example, the agent can set an initial state of transformation space 138-1 to be (0, 0, 1) for (α, β, γ).

Then, the action planner selects from a list of available actions by referring to the Q-table 110, and then agents for each of the environments make a transition from the initial state to the next state. Afterwards, the action planner combines each of the states from each of the environments into a model. As mentioned, each state of each environment or channel corresponds to the transformation parameter combination. For example, equation 5 illustrates the model.

After the action planner creates the model, the action planner generates a parameterized sales function and corresponding metrics for the parameterized sales function. Then, the action planner calculates a distance function metric for each of the generated metrics of the parameterized sales function, such as with the distance function metric equation of equation 7. Following the calculation of the distance function metric, the action planner computes a summation of predefined thresholds and computes a normalized score threshold. The normalized score threshold is used for attaining the ratio P, which is used to calculate the entropy equations. The action planner calculates the entropy using the ratio P to quantify the parameters of the model. The resultant value of entropy tells the action planner how far the model is from the desired business objective output.

During stage (B), the action planner determines whether the change in states of the model results in a high reward. In some implementations, the action planner can determine whether the transition between states was an optimum movement. For example, the action planner can rely on response surface methodology that enables movement between regions of operability for transformations. Response surface methodology (RSM) is a collection of mathematical and statistical techniques useful for the modeling and analysis of problems which help to sequentially reach a region of optimum. To reach the region of optimum, neighborhood search can be performed in the region of operating conditions and following the path associated with an increase in information gain or a reduction in entropy. The region of operability or optimum includes various business objective contours, and the ultimate goal is for the action planner to move the current transformation parameters for the transformation spaces to a region of an optimum transformation parameter set. By moving into the region of optimum transformation parameter, the action planner can determine a near zero or zero entropy model that correspondingly has a low or zero uncertainty state. In some implementations, the action planner determines a proposed reward policy value using equation 11 to determine whether the change in states of the model results in a high reward.

During stage (C), the action planner implements a policy control to find an optimal set of actions for the environments from the learnt actions. The action planner can utilize equation 21 to find the optimal set of actions for the environments from the learnt actions. Based on the values determined from equation 21, the action planner can store the values in the Q-table.

During stage (D), the action planner provides each agent with a set of actions to take. The agent within an environment transitions the transformation space from the previous state to the next state. For example, as shown in process 103, the agent moves the state of the transformation space by reducing the lag by one unit. In this example, the resultant transformation parameters after the state transition are now 0.369, 0.215, 0.213, and 0.766. Afterwards, the action planner performs the stages (A) through (D) using the newly updated states to calculate new entropy and corresponding reward values. This process repeats a predefined number of times or until entropy is determined to be zero. When this final condition is met, the final tuned model of equation 5 is output to the client device. Additionally, the action planner can output a recursively trained machine-learning model for use by the individual to identify promotional characteristics that aid in determining optimum promotions for a maximizing activity for a sales opportunity.

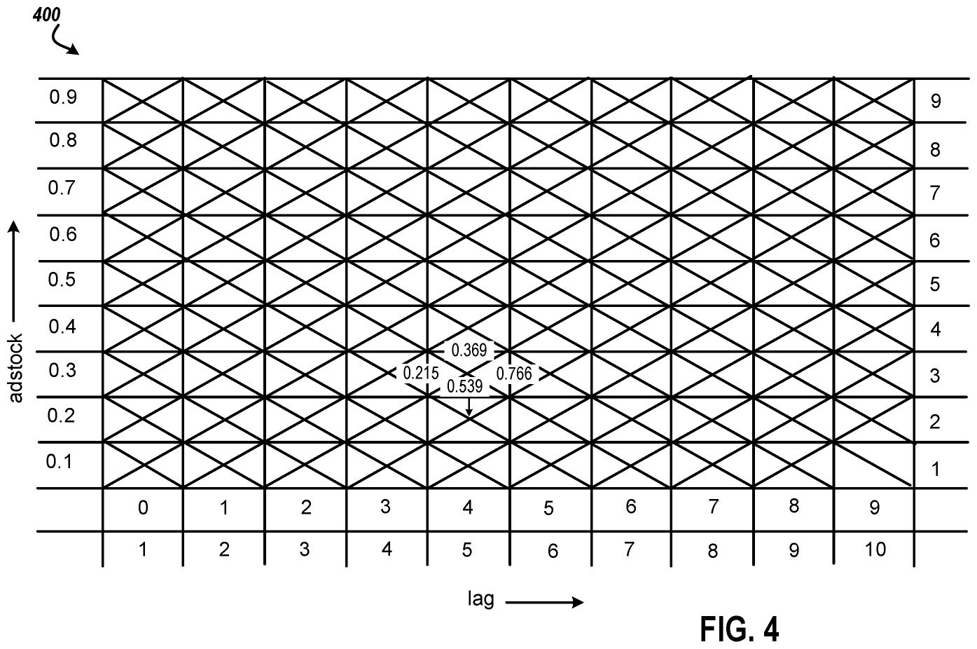

FIG. 4 is an example of a transition between two states based on the promotional channel in 2D transformation space. For example, FIG. 4 illustrates a two dimensional view of a transformation space that illustrates four different state values, e.g., 0.215, 0.369, 0.766, and 0.539. These values can represent the adstock and lag, each of which corresponds to characteristics of a promotional channel. The values of adstock range from 0.1 to 0.9 and the values of lag can range from 0 to 10, in this particular example. Other examples of ranges are also possible.

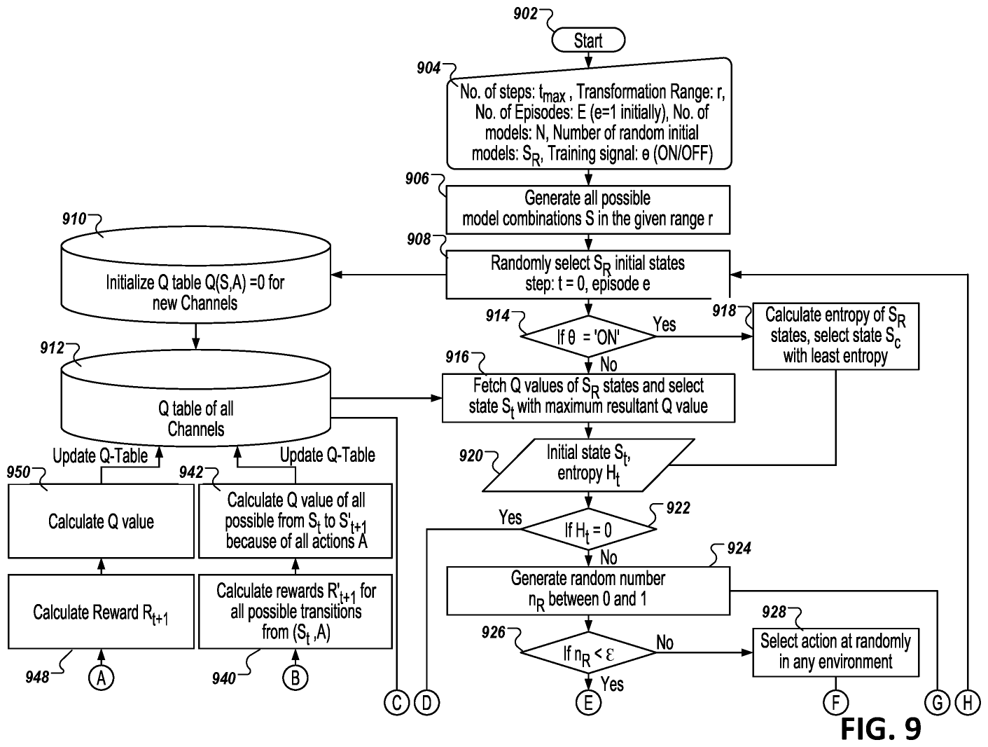

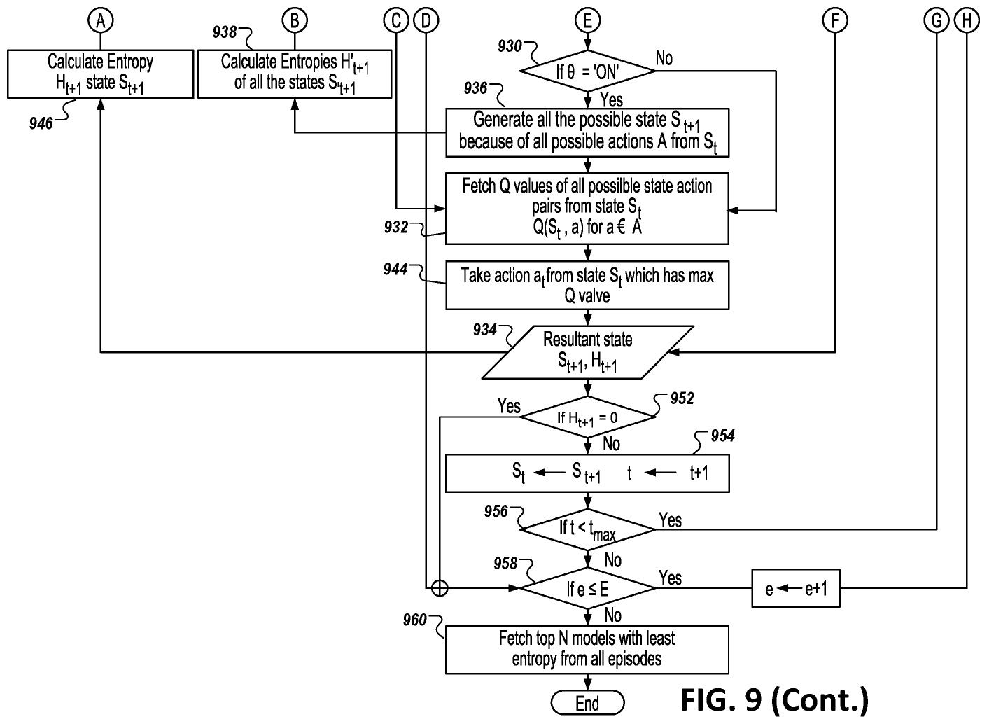

FIG. 9 is a flow diagram that illustrates an example process 900 of generating a model based on reinforcement learning and marketing mix modeling. The modeling server 102 can perform the process 900.

The modeling server 102 can initiate the process of interfacing with a user to generate one or more models for determining various promotional effects on a sale opportunity (902). The user can provide data that instructs the modeling server how to generate and build the statistical model. The modeling server can use the data to execute a plurality of simulations and output a model that has zero or near zero entropy and meets the requirements defined by the user.

The modeling server can set transformation range r for each promotion channel for building a model at starting of each episode e (904). One episode represents the number of steps times the modeling server iterates through stages (C) through (L), as illustrated in system 100. The number of episodes (E) can be defined by the user or defined by the number of iterations taken to reach an entropy of zero or near an entropy of zero for a particular model. The modeling server can set the number of steps tₘₐₓ for each episode the user wants the server to iterate. The modeling server can also set number of models N. At the end of all the iterations, the modeling server will fetch N models which has the least entropy. The training signal θ can be set to ON by the modeling server in initial episodes for which will enable the RL algorithm to fast learn about the environment. The modeling server can also set training signal θ to OFF when there is enough learning.

The modeling server can generate multiple model combinations, e.g., all possible model combinations S in the given range R (906). For example, the modeling server can generate a number of transformation spaces for modeling, where each transformation space is representative of a particular promotional channel that undergoes one more or more transformations. In such case, the modeling server may generate eight transformation spaces, each space being modeled under 3 transformations for a combination of (1000)⁸ possible transformation combinations, e.g., (10³)⁸. The modeling server may select another number of transformation spaces for modeling in other examples.

The modeling server can randomly select S_{R} initial states or models from S model combinations (908). In particular, the modeling server can select random states from each environment. The random state for each environment is the initial states from which an agent from each environment can make a transition to another state. The state of each environment can be the transformation parameter combination for each channel in the transformation, such as (1, 0.2, 0.1) for (α, β, γ). The modeling server can select a random state for each environment to ensure that an agent for a respective environment has sufficient exploration of the corresponding transformation space.

The modeling server can initialize a Q-table, e.g., [Q(S, A)=0], for new channels identified by the modeling server (910). The Q-table can store the Q-values of the state transitions from one state to another. Initially, the Q-table may not include state changes and corresponding reward values. Once the modeling server has transitioned between states for respective transformation, then the Q-table can be updated with corresponding Q-value of the state change. The Q-values updated can be based on metrics that include, for example, proposed distance metrics, the normalized ratio values, entropy values, a corresponding proposed reward value and the current Q-value.

The modeling server can add the Q-tables for the newly initialized channels to the Q-table of all channels (912). For example, the modeling server can add one Q-table for each newly identified channel to the previously created Q-tables from previously run simulations. In this manner, the modeling server can track the new Q-tables with the old Q-tables in a similar location. The modeling server can access a Q-table by index in a database that stores each of the Q-tables.

The modeling server can fetch a Q-value of the S_{R} states or models and select a state Sₜ of each of the transformation space, which has a maximum Q-value (916) when training signal θ is OFF (914). For example, the modeling server may select from the database of Q-table storing an available set of actions, an action for the agents for each corresponding environment to transition their transformation space from one state to another state. This movement from one state to another state is equivalent to a gambler pulling a random arm of slot machines initially to play in a sequence of trials to maximize the reward. For example, if the channel 1/bandit 1 has a state of (1, 0.2, 0.1), and agent for the channel 1/bandit 1 can transition the channel 1/bandit 1 to a new state of (2, 0.2, 0.1), by incrementing the alpha value. Alternatively, the modeling server can calculate the entropy of S_{R} states when training signal θ is ON (918) and select state Sₜ with the least entropy Hₜ as an initial state at step t=0 (920). If the entropy Hₜ is zero (922), then the modeling server will exit from all the steps in the current episode and skip to the next episode (958).

Thus, the modeling server can generate a combined model or state Sₜ by combining the states of all the environments. The state of the combined model is represented by the combined transformation parameter combination from each transformation space after the transition has occurred. The modeling server can evaluate the effectiveness of the combined model using various metrics.

The modeling server can generate a random number n_{R} between 0 and 1 if the entropy Hₜ is not zero (924). The modeling server may utilize a random seed generator to generate the random number. Alternatively, the modeling server may utilize other functions to generate the random number.

The modeling server can compare the generated random number to the value E of an epsilon greedy policy (926). The modeling server compares the random number to the value E to determine an estimated value of taking an action against all possible actions, e.g., transitioning between states of a transformation space.

If the generated random number is not less than the value E, e.g., is greater than or equal to, then the modeling server may select an action at randomly in any of the environments or transformation space (928). The action can correspond to transitioning the state of any transformation space. The resultant state in this step is Sₜ₊₁ having entropy Hₜ₊₁ (934).

If the generated random n_{R} is less than the value E and the training signal θ is OFF (930), then the modeling server can directly fetch Q-values of all possible state-action pairs [Q(Sₜ, a) for a∈A] from state Sₜ (932). Alternately, if the training signal θ is ON, the modeling server can generate all the possible states Sₜ₊₁′ because of all possible actions A from state Sₜ (936). The modeling server can then calculate entropies Hₜ₊₁′ of the states Sₜ₊₁′ (938) and can update the Q-values of all the state action pairs [Q(Sₜ, a) for a∈A] (942) by calculating the rewards Rₜ₊₁ (940). The resultant state of the environments is Sₜ₊₁ having entropy Hₜ₊₁ (934) when the modeling server selects an action at from state Sₜ that corresponding to a max Q-value (944). This action can correspond to transitioning the state of any transformation space that has a maximum Q value previously. For example, if the modeling server adjusted the value of R for a transformation space previously, and that adjustment resulted in the greatest Q-value being generated, then the modeling server can apply a similar adjustment to this transformation space at this process.

The modeling server can determine a resultant state Sₜ₊₁ after applying adjustments to the transformation space (934). The output processes from stages 944 and 928 can be fed into this stage 934. For example, the modeling server can determine the resultant state Sₜ₊₁ at step t+1 after the action is taken.

The modeling server can determine or calculate an entropy Hₜ₊₁ of state Sₜ₊₁ (946). Using the combined modeling equation, the modeling server can compute a distance function metric for the combined equation, as illustrated in equation 7 above. Then, the modeling server calculates a total score for the combined model using equations 8 and 9 above. Following that, the modeling server can calculate an entropy value to identify the existing uncertainty of the model in terms of achieving the business objectives. The modeling server can use equation 10 to calculate the entropy of the model.

The modeling server can determine or calculate reward based on the calculated entropy of the model, which takes into account both intrinsic and extrinsic gain (948). For example, using equation 11 above, the modeling server can calculate the reward for the quality of the move or action taken from a previous state Sₜ to a next state Sₜ₊₁. The higher the entropy for the transitioned state, the larger the uncertainty and the lesser the reward for the action. Alternatively, the lower the entropy for the transitioned state, the lower the uncertainty and the greater the reward for the action. Thus, the reduction in entropy for a transition between states is directly proportional to the reward.

The modeling server can determine the Q-value of the action at taken by the modeling server when transitioning the transformation state from Sₜ to Sₜ₊₁ (950). Specifically, the modeling server generates a data object that include the Q-value calculated in stage 950 with the action at taken by the modeling server when transitioning between transformation states. The modeling server can store the generated data object with this information in the Q-table database for later retrieval (912).

The modeling server can compare the value of Hₜ₊₁ to zero (952). If the value of Hₜ₊₁ is equivalent to zero, then the modeling server will exit from all the steps in the current episode and skip to the next episode (958). However, if the entropy value Hₜ₊₁ is not zero, then the modeling server sets Sₜ₊₁ to Stand t+1 to 1 (954). Then, the modeling server can compare a value of step t to a value of tₘₐₓ (956). The value of t can be a current step of the transition, and the value of tₘₐₓ can be a maximum number of steps modeling server can take in any episode e. In this case, if the value of the current step t is less than the value of the maximum step tₘₐₓ, then the modeling server returns to stage 924 for the next iteration of transitioning the transformation spaces and subsequently calculating a corresponding Q-value by generating a new random number n_{R} between 0 and 1 (924).

However, if the value of t is greater than the value of tₘₐₓ, then the modeling server can determine whether the value e is less than the value of E (958). E is the number of episodes user wants modeling server to execute where “e” is any value between 1 and E (e=1, 2, 3, . . . , E).

The modeling server can end the process 900 if the value of “e” is greater the value of “E” (960). If the modeling server ends the process 900, then the modeling server can output the top N models with zero or least entropy among all the episodes to the user to their respective client device. However, if the value of “e” is less than the value of “E”, then the modeling server sets “e+1” to “e” and returns to randomly select S_{R} initial states with step: t=0 and episode equal to the updated value of “e” (908).

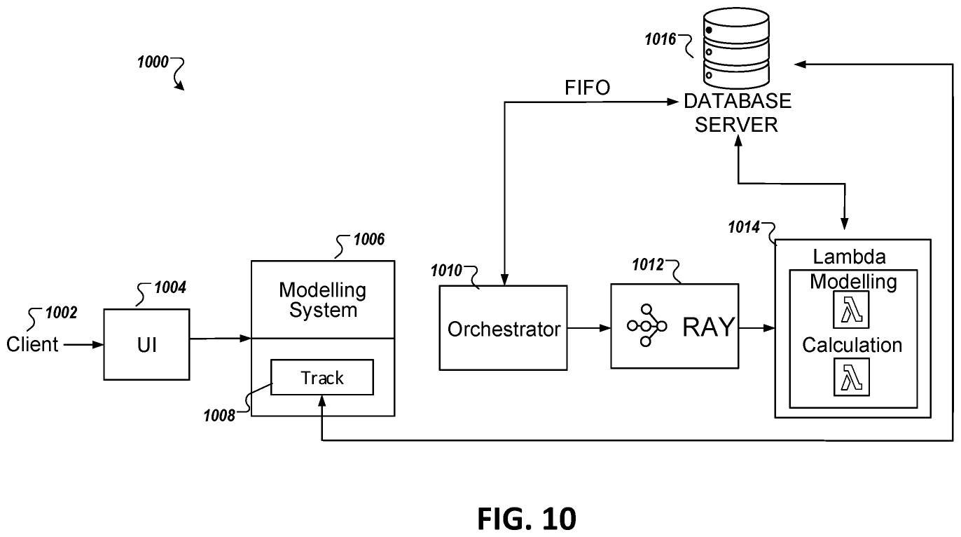

FIG. 10 is a block diagram that illustrates an example of technological framework 1000 for the system that generates a model using reinforcement learning and marketing mix modeling. The technological framework includes specific components to perform the functions discussed and described in this specification. For example, the technological framework 1000 includes client device 1002, a user interface 1004, a modeling system 1006 with a track module 1008, an orchestrator 1010, ray distributed processing 1012, lambda processing 1014, and a database server 1016. The modeling server can include components 1004 through 1016.

The client device 1002 and the user interface 1004 can include a user and their respective client device, e.g., personal computer, mobile phone, handheld device, tablet, or other device for instructing the modeling server to perform the functions described through the specification. The client device 1002 can represent external users that communicate over the internet through a particular certificate, e.g., SSL, through a DNS web service and managing private certificates. These can include Route53 and AWS Certificate Manager (ACM), to name a few examples. Other examples are also possible to allow developers to be more agile by providing APIs to create and deploy private certificates programmatically. The user can communicate through the user interface 1004 on the client device 1002 to instruct the modeling server to generate statistical models.

The modeling server can include a modeling system 1006 and a track module 1008. The modeling system 1006 and the track module 1008 can be used to load balance the incoming traffic. For example, thousands of client devices may be communicating with the modeling server and requesting statistical models, and the modeling system 1006 can manage and balance the incoming traffic and output generated models for each of the client devices. For example, the modeling server can rely on an Elastic Load Balancing (ELB) module that distributes incoming application traffic and scales the processing resources to meet traffic demand requirements.

The modeling server can include an orchestrator 1010. The orchestrator 1010 can be a local or cloud-based container daemon service. The daemon service is a background, non-interactive program which runs as an isolated service continuously.

The modeling server can include ray processing 1012. The ray is a fast, simple distributed execution framework that makes it easy to scale and trigger multiple lambdas.

The modeling server can include lambda processing 1014. The lambda processing 1014 can be used for efficient modeling and calculation.

The modeling server can also include a database server 1016. The modeling system APIs will interact with the database server which fetch the write the various states and stages of the lambda jobs.

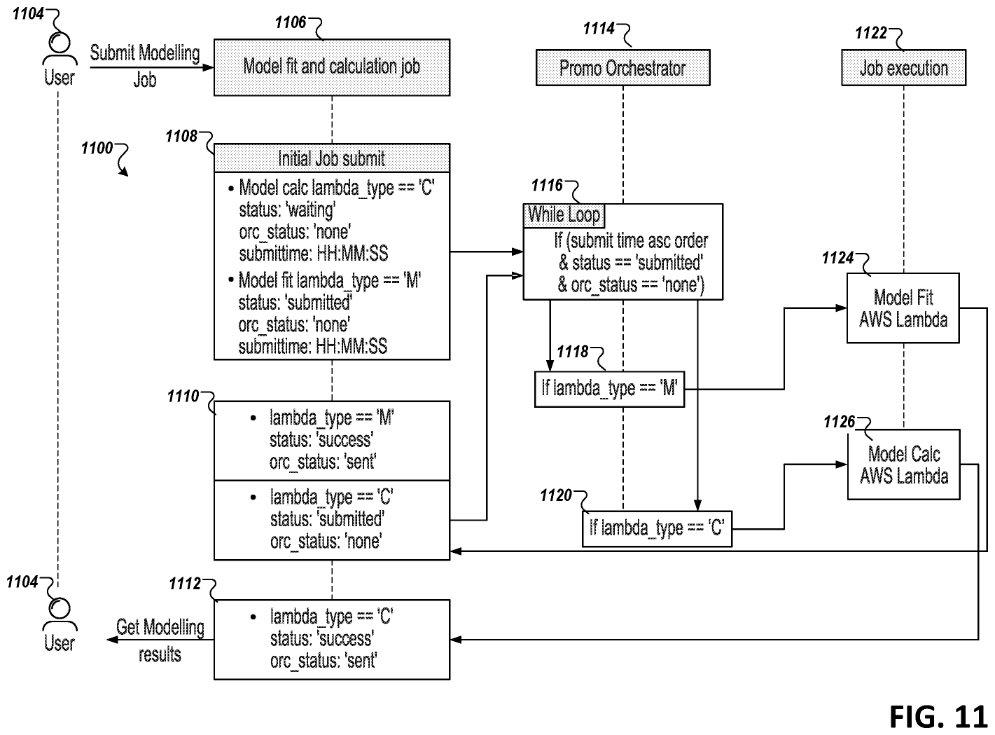

FIG. 11 is a flow diagram that illustrates an example of a process 1100 of a technical framework for producing a model. The process 1100 illustrates processes performed by the modeling server for generating and returning modeling results. In particular, the process 1100 illustrates the processes performed by the user 1104 submitting a modeling request, receiving the results of a model, and the processes performed by the ray processing 1102.

The user 1104 can submit a modeling job to the modeling server. At 1106, the modeling server can perform functions related to model fit and calculation of job. At process 1106, the modeling server initiates a job submission to database server. The job submission can include various parameters such as a modeling lambda_type==‘C’, with status of “waiting”, an orc_status of “none,” and a submit time of HH:MM:SS. The modeling lambda_type can also be ==‘M’, with a status of “submitted,” an orc_status of “none,” and a submit time of HH:MM:SS. After the job submission has been completed the promo orchestrator 1114, which is the daemon process, pics the jobs for modeling.

At process 1116, the modeling server executes a while loop that-iterates under the condition of “if(submit time asc order & status==‘submitted’ & orc_status==‘none’).” In the process 1116 the jobs are sorted in ascending order of time and with the conditions status==‘submitted’ and orc_status==‘none’. In the process 1116 jobs are filtered based on the above-mentioned conditions. If the modeling server determines that the lambda_type variable==‘M,’ then the modeling server proceeds to process 1124, where the model fit AWS lambda process is performed. Alternatively, if the modeling server determines that the lambda type variable==‘C,’ then the modeling server proceeds to process 1126, where the model calculation AWS lambda process is performed.

After process 1124, the modeling server updates the variables to process 1110. If the lambda_type==‘M,’ then the status is set to ‘success’ and the orc_status is set to ‘sent.’ If the lambda_type==‘C,’ then the status is set to ‘submitted’ and the orc-status is set to ‘none’. In the process 1110 the modeling server updates the status and orc_status of modeling lambda_type==‘M’ and lambda_type==‘C’ once the model fit is completed by process 1124. In the next iteration of 1116, the lambda_type==‘C’ jobs whose status is updated to ‘submitted’ and orc_status to ‘none’ will get sorted in the condition and will be sent to process 1120 since it is of lambda_type==‘C’. In the next step 1120, the process will send these jobs to 1126 Model Calc AWS Lambda to perform model calculations. At process 1112, the modeling server sets the status to ‘success’ and the orc_status to ‘sent’ if the lambda_type==‘C’ and the modeling server has finished the modeling and calculations. Then, the modeling server provides the modeling results to the user 1104, e.g., the resultant model that meets the parameter constraints set by the user 1104.

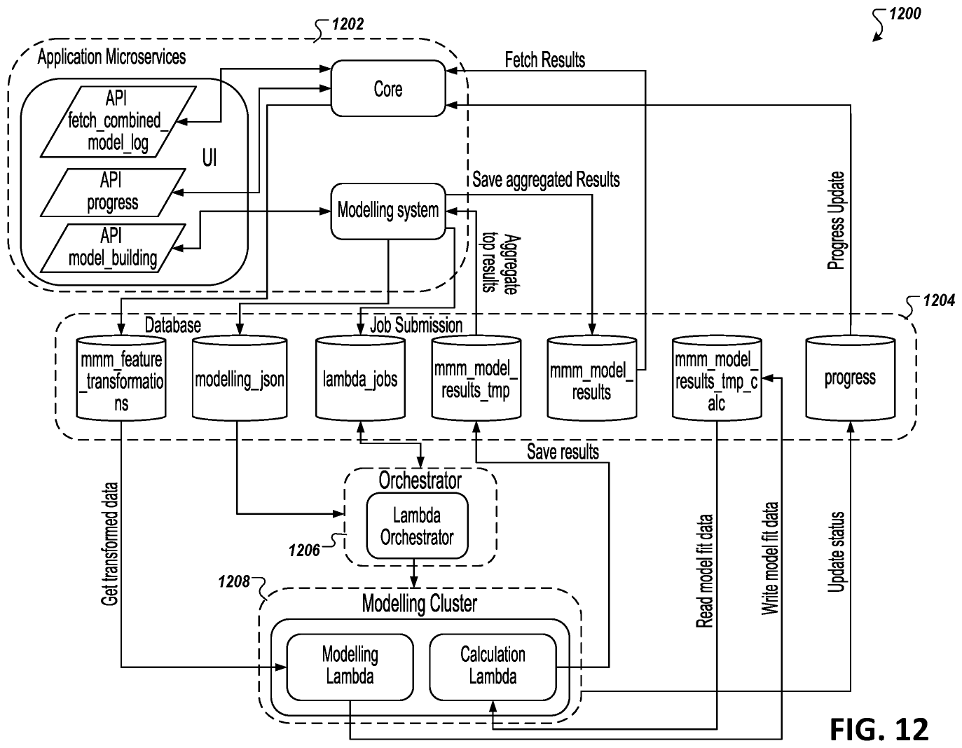

FIG. 12 is a block diagram that illustrates an example of a system 1200 for database microservice interaction for modeling. In particular, the system 1200 illustrates the components and the services implemented for receiving modeling instructions and for generating a model. The system 1200 includes application microservices 1202. The application microservices 1202 has three important services named as User Interface, Core and Modeling System, which can include multiple APIs for executing the simulations and building the model. In particular, the multiple APIs can include, for example, a fetch_model_log API, a progress API, and a model_building API. The User Interface communicates with core service using endpoints, for example, fetch_model_log API and progress API. Similarly, the User Interface communicates with modeling system service using endpoints, for example, model building API. Moreover, the core service and the modeling system can communicate with various databases.

The modeling server also includes database 1204. The database 1204 can include multiple collections, for example, mmm_feature_transformations, modeling_json, lambda_jobs, mmm_model_results_tmp, mmm_model_results_level, mmm_model_results_tmp_calc, and progress. The modeling system service submits the modeling jobs to lambda_jobs collection and corresponding modeling parameters are stored in modeling_json collection when it receives the modeling request from decision support system. Once the jobs are submitted, the orchestrator 1206 will pick the jobs and sent to modeling cluster 1208. Based on the type of job, the modeling cluster 1208 will send the jobs to modeling lambda and calculation lambda. The modeling lambda will fetch the transformed data from mmm_feature_transformations which is required for model fit. The progress of the both the lambdas are sent to the progress collection of database 1204. The user will get the real time status update of the job through the endpoint in core service. The results are stored in mmm_model_results_tmp collection of database 1204. The modeling system service aggregates the results and save to mmm_model_results collection. The core service can communicate with the mmm_model_results to fetch model logs.

The modeling server also includes an orchestrator 1206 that performs as the daemon process picks the jobs and sends the jobs in queue to the modeling cluster on FIFO basis (First In First Out). Specifically, the orchestrator 1206 can include a lambda orchestrator that performs the modeling functions and communicates with a modeling cluster 1208, a lambda_jobs database, and a modeling cluster 1208.

The modeling cluster 1208 can include a modeling lambda function and a calculating lambda function. The modeling lambda receives the transformed data from mmm_feature_transformations collection and performs the model fitting. The model fit data is saved to mmm_model_results_tmp_calc. The calculation lambda reads this data when it is invoked and after all the calculation and predictions the data is stored in mmm_model_results_tmp. The calculation lambda performs prediction and calculates ROI, MAPE, Volume contributions per channel, total volume contribution, p-value, DW statistic, etc.

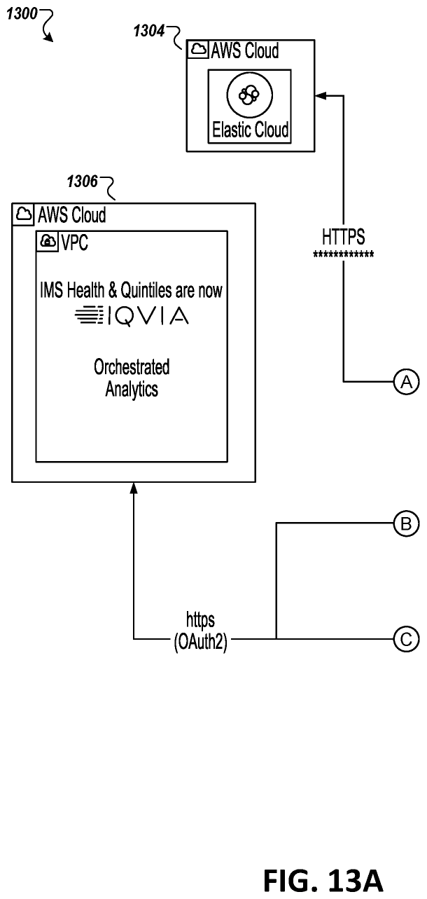

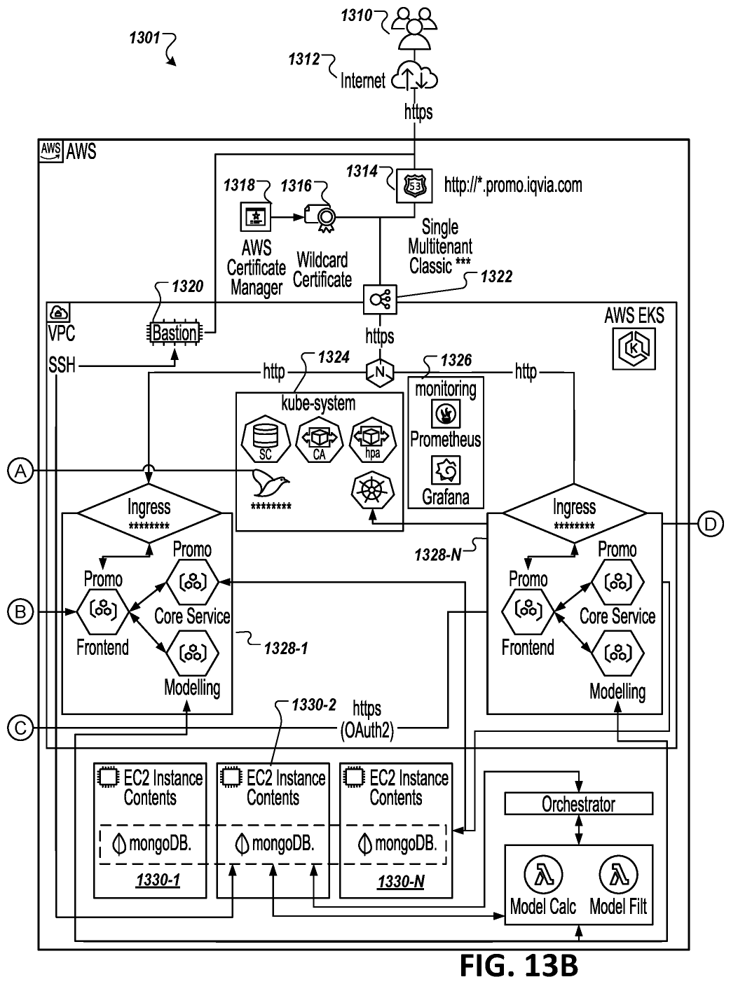

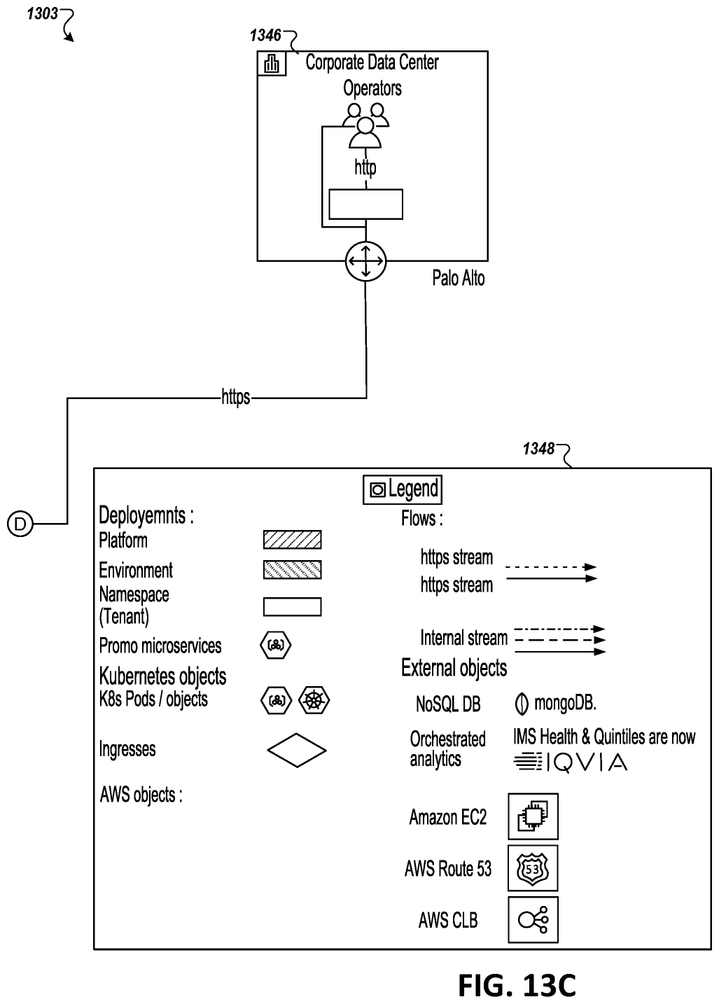

FIGS. 13A-13C are block diagrams that illustrates an example of a system 1300 of physical architecture of a decision support system. The system 1300 illustrates various components and how these components connect to other components illustrated and described with respect to FIGS. 13A-13C. In particular, the system 1300 includes an AWS cloud 1304 that includes an elastic cloud service, which receives HTTPS indexing from components within FIG. 13B. The elastic cloud allows you to store, search, and analyze big volumes of log data quickly and in near real time. The AWS cloud 1306 contains the tenant for Orchestrated Analytics, which handles the user authorization and authentication. The AWS cloud 1306 communicates via https over OAuth2 to components within FIG. 13B.

FIG. 13B is another block diagram that illustrates an example of a system 1301 of physical architecture of a decision support system. The system 1301 illustrates various components and how these components connect to other components illustrated and described with respect to FIGS. 13A, and 13C. In particular, the system 1301 includes users 1310, the internet 1312, a cloud domain name service (DNS) 1314, a wildcard certificate 1316, a certificate manager 1318, a bastion host 1320, a load balancer (ELB) 1322, Kubernetes system 1324, and a monitoring system 1326 which includes Prometheus and Grafana. A Route 53 1314 is intended for managing DNS for services and machines deployed on AWS. An AWS ACM 1318 and wildcard certificate 1316 matches any first level subdomain or hostname in a domain. For example, a wildcard certificate issued for * (http://*.promo.iqvia.com). A bastion 1320 is a special purpose EC2 server instance that is designed to be the primary access point from the Internet and acts as a proxy to Mongo DB EC2 instances 1330-1 through 1330-N. Elastic Load Balancing (ELB) 1322 automatically distributes incoming application traffic across multiple targets and virtual appliances in one or more Availability Zones (AZ's). The ELB component 1322 communicates with nginx acting as an ingress which is an API object that provides routing rules to manage external users access to the services in a Kubernetes. The Kubernetes system 1324 can communicate with the elastic cloud 1304 from FIG. 13A via fluentd which acts a log collector. Additionally, the Kubernetes system 1324 can communicate with the components in FIG. 13C, as will be further described below.

In system 1301, the users 1310 can connect to the ELB 1322 by submitting their respective certificates 1316 through the cloud domain service 1314 and having the certificate approved by the certificate manager 1318. After being validated to use the services described and illustrated in FIGS. 13A-13C, the users 1310 can submit their request to initiate the modeling process. The system 1301 can be implemented by, for example, the AWS route53 process, the AWS ELB (elastic load balancer), the NGINX proxy, the AWS EKS (elastic kubernetes service) for Kubernetes, the bastion host process, monitoring system Prometheus and Grafana, and Fluentd as illustrated and described.

Moreover, the system 1301 includes an ingress tenant 1328-1 through ingress tenant-n 1328-N, mongoDB databases 1330-1 through 1330-N. Specifically, the MongoDB components 1330-1 through 1330-N can use a mesh database architecture for high availability. This mesh database architecture can include a database deployment which is a replica-set and deployed in multiple zones for high availability. A replica-set is a group of Mongo DB instances that maintain the same data set. A replica set contains several data bearing nodes and optionally one arbiter node. The tenant which is deployed on the AWS Kubernetes cluster consists of promo frontend microservice, promo core service, and promo modeling microservice. These microservices interact with each other and Mongo DB. The promo modeling microservice interacts with orchestrator, AWS Lambdas (fit and calc) and Mongo DB to perform model fit and model calculations. These are discussed in detail in FIGS. 11 and 12.

FIG. 13C is another block diagram that illustrates an example of a system 1303 of physical architecture of a decision support system. The system 1303 illustrates various components and how these components connect to other components illustrated and described with respect to FIGS. 13A and 13B. In particular, the system 1303 includes a corporate data center 1346 and a legend 1348 for each of the FIGS. 13A-13C. The corporate data center 1346 can be a data center that manages IT issues associated with systems 1300, 1301, and 1303, that can be accessed via AWS security operation platform, for example, Palo Alto. The users located at the corporate data center 1346 can access the components within the Kubernetes EKS cluster over HTTPS by way of its connecting to components within FIG. 13B to the kubernetes system 1324.

Additionally, the system 1303 can include a legend 1348. The legend 1348 can indicate, for example, a platform, an environment, a namespace, promo microservices, kubernetes objects, K8s Pods/objects, and Ingresses. Additionally, the legend 1348 can illustrate flows of data by way of an https stream, http stream, and internal stream, to name a few examples. Additionally, the legend 1348 can illustrate various external objects provided in the systems 1300, 1301, and 1303. The external objects can include, for example, NoSQL DB, Orchestrated analytics, Amazon EC2, AWS Route 53, and AWS CLB, to name a few examples.

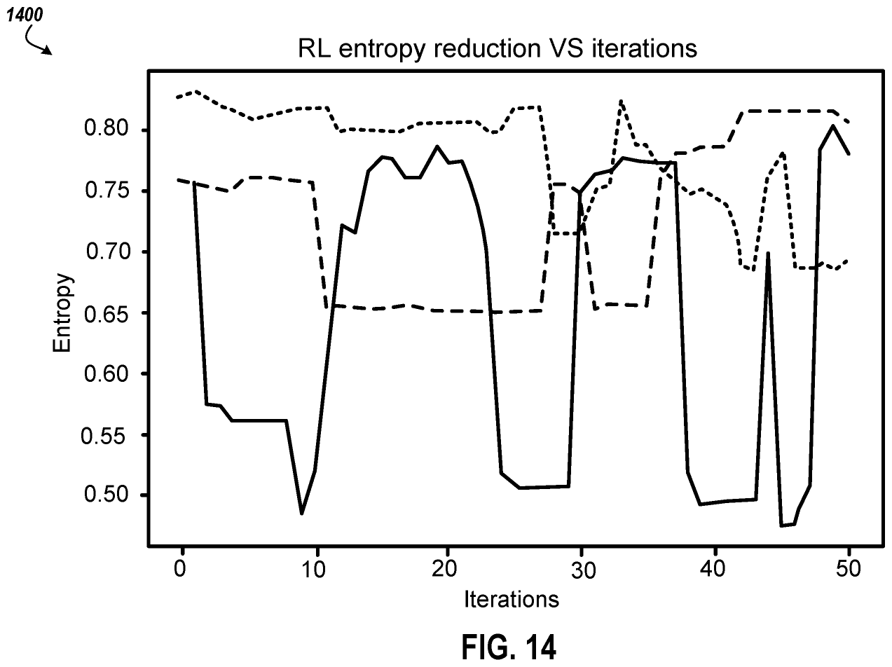

FIG. 14 is a graphical representation 1400 that illustrates reinforcement learning (RL) entropy reduction for initial episodes. In particular, the graphical representation 1400 illustrates various reinforcement learning entropy reduction over various iterations performed by the action planner. The graphical representation 1400 illustrates the best entropy scores at every step for three random episodes. The graphical representation 1400 illustrates oscillations and sudden jumps during the iterations because in the initial episodes, the agents for each of the environments are unaware of the environments and learning through experience by visiting the states of the environments.

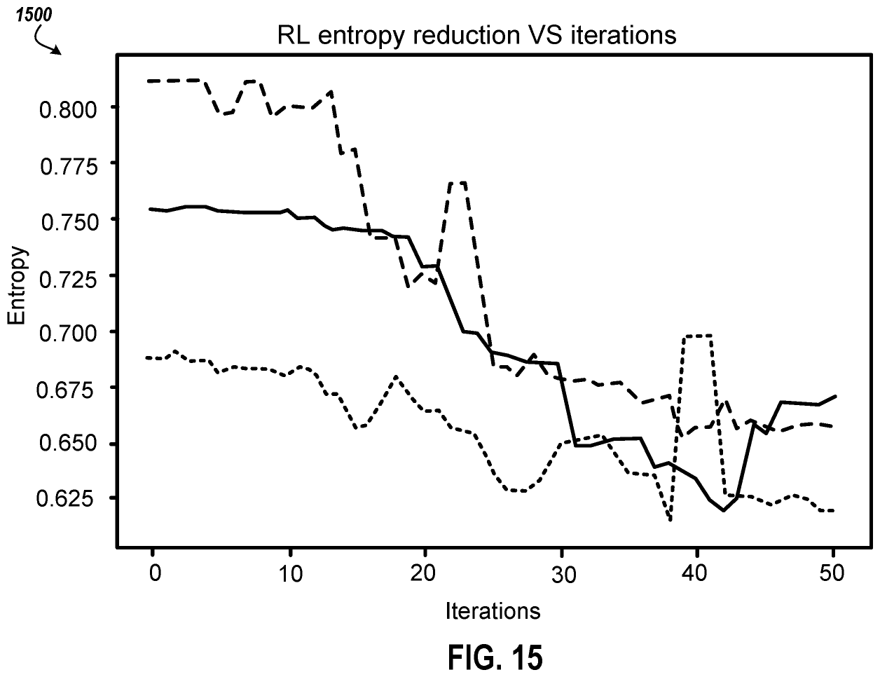

FIG. 15 is a graphical representation 1500 that illustrates RL entropy reductions after 50 episodes. The graphical representation 1500 shows the graph of best scores at different steps in reinforcement learning for three random episodes after 50 episodes. The decreasing trend is observed for each episode in the iterations, which indicates that the agent has learned high rewarded state transition actions from the visited states. Additionally, the agent can continue to improve its rewarded state transition actions as it continues to learn the environment.

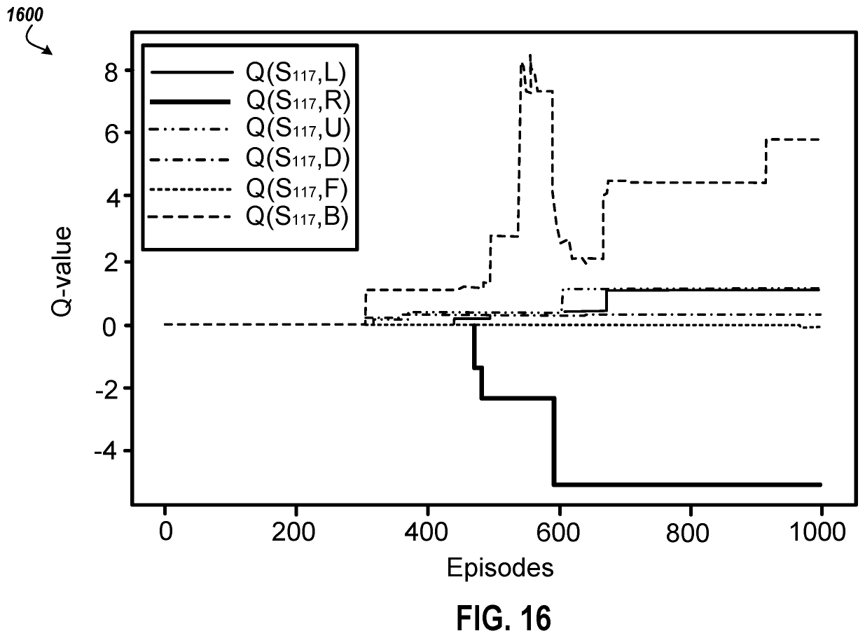

FIG. 16 is a graphical representation 1600 that illustrates episodic Q value update of any state of any environment. The Q-values of one state for all the actions are illustrated in the graphical representation 1600, for 1000 episodes. The Q-values are updated whenever the agent visits the state which is being tracked in each episode. For action B, the Q-value is shown to be an increasing trend and for action R, a decreasing trend over episodes is observed. The values of L, U, D, and F do not show many improvements and the corresponding Q-values are close to zero. In future iterations, if the agent visits the same state again, the agent is more likely to select the actions with high Q values, for example, in this case B action, as the agent will receive the maximum expected reward, likely leading the agent closer to a feasible solution. Thus, it is expected that the agent can select action following the epsilon greedy policy over the period of time as the agent learns of the environment.

By iteratively storing data in the Q-table 110, the path of the decision that led to the final feasible model can be analyzed to determine how the action planner arrived at the final model. The entropy based scoring function is designed to quantify the multi objective promotional functions, such that at every iteration, the action planner can quantify a distance between the model and the desired promotional goal or business objective.

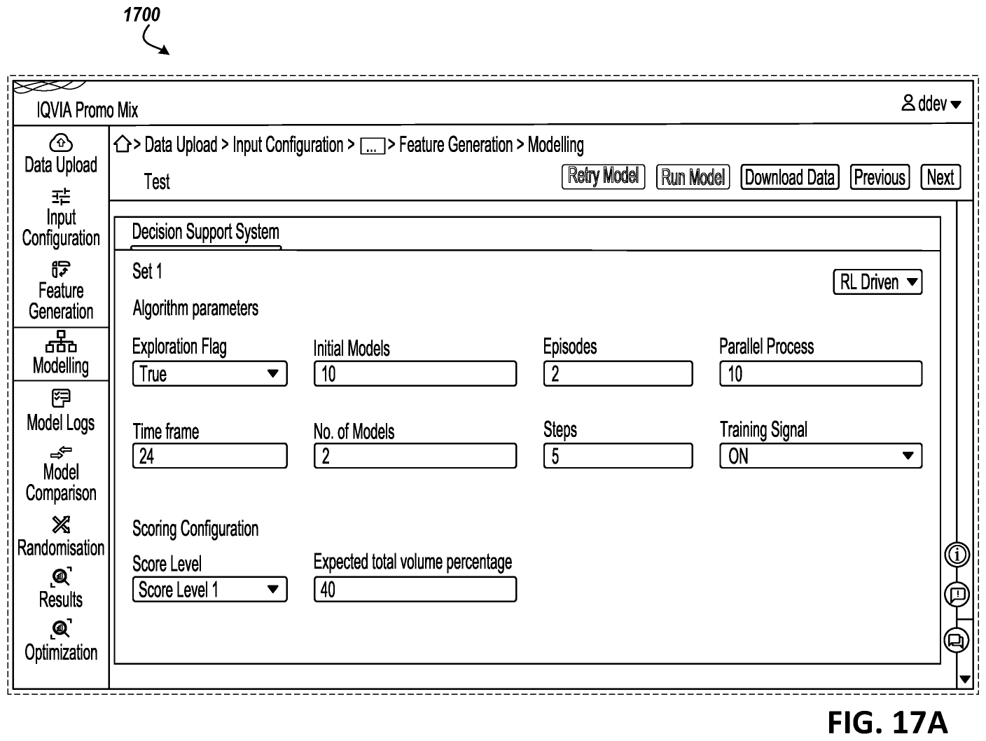

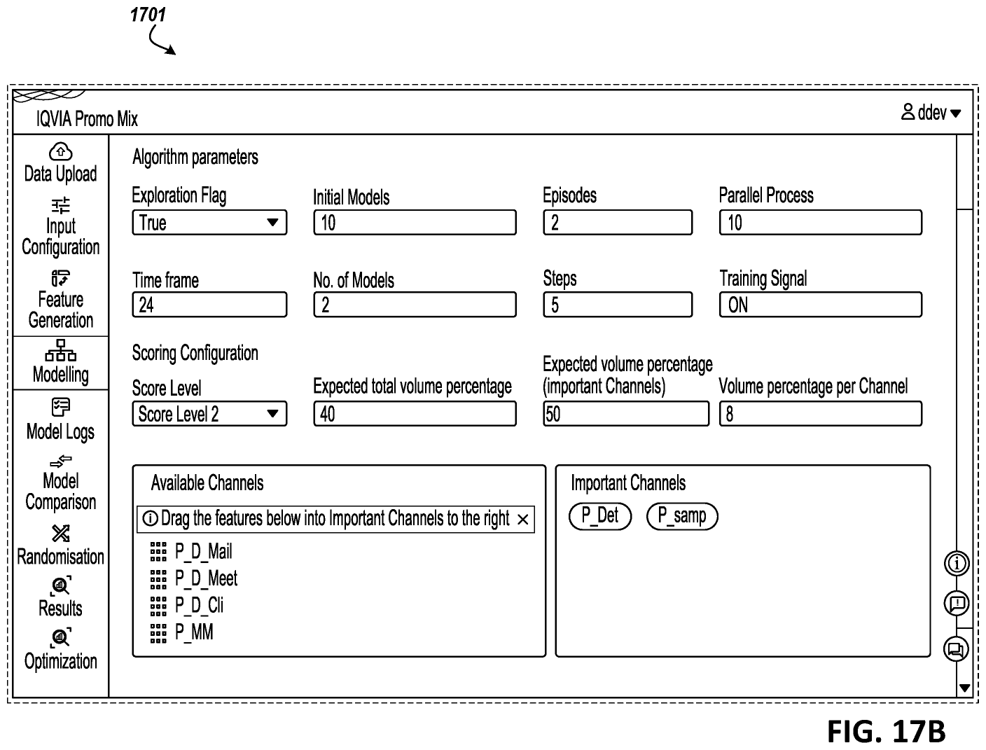

FIGS. 17A and 17B are examples of user interfaces, e.g., user interface 1700 and user interface 1701, respectively, that enable users to provide parameters for executing simulations to generate a model. FIGS. 17A and 17B illustrate user interfaces for a user to interact with the modeling server, such as modeling server 102. The user interface enables the user to provide inputs for executing the processes performed by the action planner to generate a feasible model. FIG. 17B illustrates a user interface in response to the user scrolling downward on the user interface shown in FIG. 17A.

The inputs can describe how the modeling server is to generate and build the statistical models. For example, the data can include algorithm parameters that describe, for example, a number of initial models, a number of episodes, a number of parallel processes, a time frame for building the model, a number of models to output, a number of steps, and a training signal. The data can also include a score level, an expected total volume percentage, an expected total volume percentage for important channels, a volume percentage for each important channel, the available promotional channels, and the important channels. The inputs can also describe data that specifies characteristics of the promotions, e.g., number ranges for lag, number ranges for adstock, and number ranges for fractional transformation.

In some implementations, the user can provide external documents to the modeling server for generating the model. The external documents include data representative of the sale opportunity. Additionally, the external documents can describe the various promotional activities for the sale opportunity, e.g., digital documents, financial documents or transaction, emails, data inputs, and other external document related to lag, saturation, decay on promotions for sales. The modeling server can ingest the external document data and can convert this data to a set of promotional standardized values, e.g., these values include lag, adstock, and fractional root values for each of the promotions. The modeling server can generate the transformational spaces using the set of promotional standardized values to determine the number of dimensions the transformations will include and the range of values for each of the promotional standardized values.

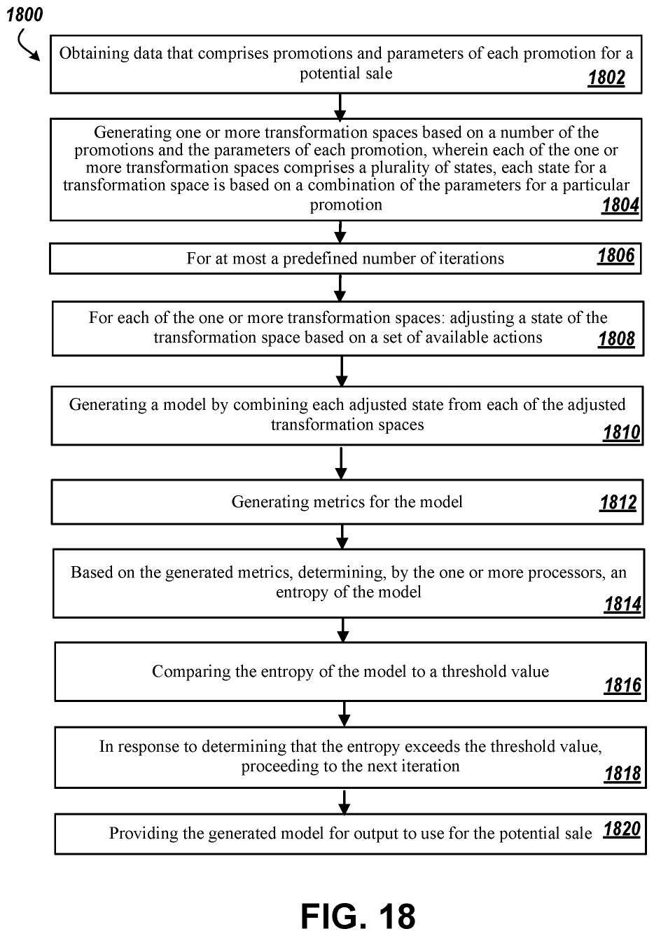

FIG. 18 is a flow diagram that illustrates an example of a process 1800 for generating a model that models impacts of promotions on a potential sale opportunity. The process 1800 can be performed, for example, by the modeling server 102, which can include one or more computers, as illustrated in FIGS. 1A-1C.

The modeling sever can obtain data that includes promotions and parameters of each promotion for a potential sale (1802). A user interacting with an interface of the modeling server or an interface of a client device that communicates with the modeling server may seek to determine “What are the effects of promotions on the sale of a shoe product,” for example. The user can provide data to the modeling server that instructs the modeling server how to generate models for analyzing how various promotions can affect the sale opportunity. For example, the user can provide data that describes, for example, a number of initial models, a number of episodes, a number of parallel processes, a time frame for building the model, a number of models to output, a number of steps, and a training signal (ON/OFF). The data can also include a score level, an expected total volume percentage, the available promotional channels, the important channels, an expected total volume percentage for important channels, and a volume percentage for each important channel. The modeling server can obtain this data from a client device associated or from the user's direct interaction with an interface coupled to the modeling server.

The modeling server can generate one or more transformation spaces based on a number of the promotions and the parameters of each promotion, wherein each of the one or more transformation spaces comprises a plurality of states, each state for a transformation space is based on a combination of the parameters for a particular promotion (1804). In particular, the modeling server can use the data provided by the user to generate one or more transformation spaces based on a promotional channel. The number of the one or more transformation spaces is represented by the number of promotions provided by the user during 1804.

The modeling server can generate the one or more transformation spaces based on a range of numbers used to define characteristics of a promotional channel. For example, the modeling server can generate an N-dimensional transformation space that holds values for of the alpha α, beta β, and gamma γ. These values can range from any sets of numbers and can be typically determined by the user or automatically determined from prior simulations. In one such example, alpha α, which corresponds to the lag on the X-axis of the N-dimensional transformation space, can vary from 0 to 9. Beta β, which corresponds to the adstock on the Y-axis on the N-dimensional transformation space, varies from 0.1 to 0.9. Gamma γ, which corresponds to the fractional root on the Z-axis of the N-dimensional transformation space, varies from 0.1 to 0.9. Alternatively, the N-dimensional transformation space may include more than or less than three variables and can include number ranges for each of the variables. The modeling server performs an N-dimensional transformation space for each promotional channel specified by the user.

The modeling server can iterate over a predefined number of iterations (1806). For example, in the case that the modeling server generated eight transformation spaces, and each transformation space is defined by three variables and each variable can range between ten numbers, then the number of transformations possible for all eight transformation spaces is 1000⁸. In this case, if the building of each model takes 1 millisecond, then the modeling server would require approximately 10¹³ years to find an optimal set of parameters from the eight transformation spaces. Thus, a smaller number of iterations within the 1000⁸ transformation spaces iterations can be used, in this particular example. In some implementations, the user can provide a number of iterations for the modeling server to execute. In other implementations, the modeling server can identify an optimal number of iterations to execute based on prior iterations run for previous model generations. For example, the number of iterations may correspond to 500 episodes, where in an episode modeling server iterates for the number of steps defined by the modeling server. Other examples are also possible.

The modeling server can adjust a state of the transformation space based on a set of available actions (1808). In particular, the modeling server can initially choose a random state for each transformation space in the initial iteration. The random state for each transformation space is the initial state for which the modeling server can transition to a subsequent state. In particular, the state of each environment can correspond to the transformation parameter combination for each channel in the transformation space. For example, the state of channel 1 of transformation space can be (1, 0.2, 0.1) for (α, β, γ). Other values are also possible for the initial random state.

In some implementations, the modeling server can also adjust a state of the transformation space. For example, the modeling server can choose an action from an available set of actions, by referring to a Q-table, and providing those actions to the agents representative of each of the transformation spaces. The agents can then transition each of their respective transformation spaces from one state to another state based on the actions provided from the Q-table. This movement from one state to another state is equivalent to a gambler pulling a random arm of slot machines initially to play in a sequence of trials to maximize the reward. For example, if the channel 1/bandit 1 has a state of (1, 0.2, 0.1), and agent for the channel 1/bandit 1 can transition the channel 1/bandit 1 to a new state of (1, 0.2, 0.2), by incrementing the beta β value. The modeling server updates the Q-table in ways based on training signal, once the agent transition from one state to another state. The details of how the Q-table is updated based on training signal is shown in FIG. 9.

The modeling server can generate a model by combining each adjusted state from each of the adjusted transformation spaces (1810). After adjusting the states of one or more of the transformation spaces, the modeling server can generate a particular model by combining each of the states from all of the transformation spaces. In particular, the modeling server can obtain the state of each transformation space, which is represented by the transformation parameter combination (alpha α, beta β, gamma γ), and combine those states to generate a model, such as the model shown in equation 5 above. In other cases, the state of each transformation space may be represented by more than or less than three transformation parameters.

The modeling server can generate metrics for the model (1812). Specifically, the model can generate metrics to perform an evaluation of the generated model. First, the modeling server can specify a parametrized sales function of the generated model. The parametrized sales function is a function that produces an output representative opportunity at a particular time based on a vector of promotional variable. Based on the generated model, the modeling server can determine metrics to characterize and evaluate the performance of the model. For example, the metrics can include beta coefficient metrics, volume contribution metrics, p-value metrics, and R2 metrics, to name a few examples. The modeling server can then calculate a distance function metric for each of the generated metrics for the model. Equation 7 illustrates how the modeling server calculates the distance function metric, as shown above. The distance function metric is used to calculate a business objective deviation, to determine a magnitude distance of how far away the model is from the user's desired business objective.

Following the determining of the distance function for each of the metrics, the modeling server can compute a summation for each of the predefined thresholds, e.g., the summation computed in equation 8. The modeling server performs the summation for each of the predefined thresholds and computes a total score from the summed predefined thresholds. The modeling server then computes a ratio value P, as illustrated in equation 9, by summing the distance function metric and the summed total score value. The ratio value P is used to determine an entropy value for the respective model.

Based on the generated metrics, the modeling server can determine an entropy of the model (1814). In particular, the modeling server seeks to determine an entropy of the model to quantify the chaos or uncertainty arising in the model due to the set transformation parameters. Ideally, the goal of the modeling server is to define an entropy-based equation that models the existing uncertainty in terms of achieving the business objective of the opportunity, and consequentially, minimizing the entropy of the model. For example, P=1 means the business objectives have each been achieved and P=0 means the business objective values are a large distance away from the expected value or defined threshold, resulting in highest entropy possible. The modeling server can use, for example, equation 10 to calculate the entropy of the model. Based on the calculated entropy of the model, the modeling server can determine actions to take.

The modeling server can compare the entropy of the model to a threshold value (1816). For example, if the modeling server determines the entropy of the model to equal 0, then the modeling server can exit the iterated loop and output the current model to the client device. Otherwise, the modeling server can continue to perform the different processes for each iteration. In some implementations, the modeling server can set a threshold for comparison to the entropy. If the entropy reaches a value that is below the threshold, then the modeling server can exit the iterated loop and output the current model to the client device. Alternatively, the user can set the threshold for comparison to the entropy. By increasing the threshold value for entropy comparison, the efficiency of the model may be reduced but the processing time may also be reduced. Alternatively, waiting for the entropy value to be zero or the number of iterations to elapse, may result in a more accurate model but the processing time may be increased.

In response to determining that the entropy exceeds the threshold value, the modeling server can proceed to the next iteration (1818). After computing the entropy of the model and determining the entropy exceeds the predetermined threshold, the modeling server can calculate a proposed reward based on the entropy of the model, which takes into account both intrinsic and extrinsic gain. The modeling server using the equation 11 can calculate the proposed reward. Each agent of a particular environment is rewarded by the action planner for the quality of the move or action taken in the given state to a next state. The reward is calculated for a transition from state Sₜ to state Sₜ₊₁ by taking action at. The higher the entropy for the transitioned state, the larger the uncertainty and the lesser the reward for the action. Therefore, reward is inversely proportional with absolute entropy (Hₜ₊₁).

The modeling server can then update and store the Q-values in the Q-table. The set of prior actions taken by each of the agents can correspond to a prior adjustment state for each of the transformation spaces. Then, in the next iteration, the modeling server can select a future action for each of the agent to take when adjusting the transformation space based on the updated Q-values. In some implementations, each agent can select a future action to take for adjusting the transformation space. For example, adjusting of the transformation space can correspond to a direction of adjusting either one or more of the alpha α, beta β, or gamma γ values for a particular transformation space by one unit. Generally, each agent should adjust the characteristics of the transformation space by manipulating their characteristics to try and identify the correct combination of characteristics, e.g., alpha, beta, and gamma values, that provide the zero or near zero entropy, and the corresponding highest reward.

After the modeling server completes iterating over the number of predefined number of iterations or episodes, the modeling server can provide the generated model for output to use for the potential sale (1820). This process iterates until the number of predefined iterations has elapsed or an entropy value of zero has been reached. When this condition is met, the modeling server outputs the generated model to the client device over the network. The user can analyze the generated model to determine which promotional attributes generate the greatest return for a particular sale opportunity.

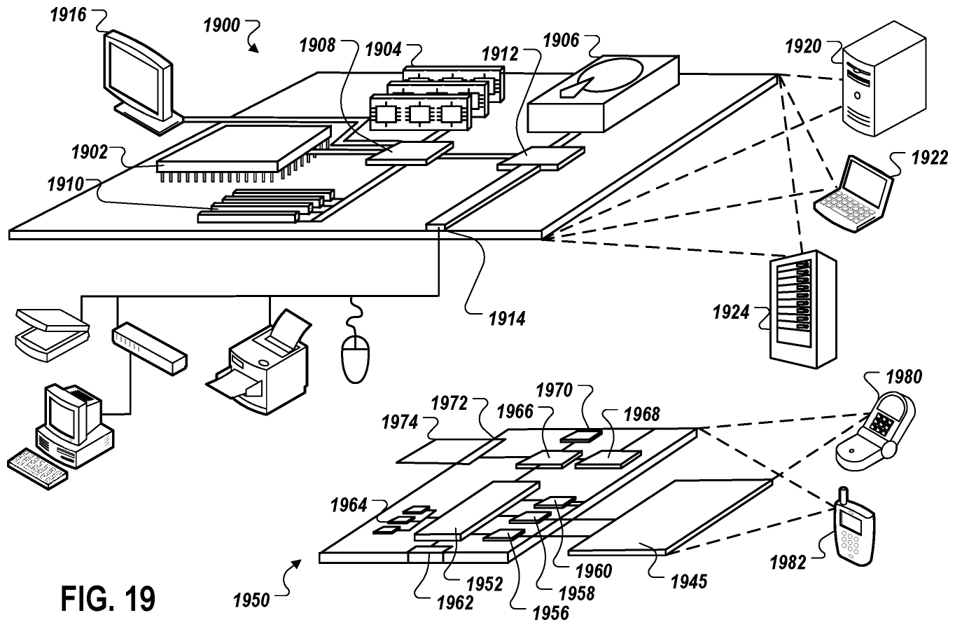

FIG. 19 is a block diagram of computing devices 1900, 1950 that may be used to implement the systems and methods described in this document, either as a client or as a server or multiple servers. Computing device 1900 and 1950 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations described and/or claimed in this document.

Computing device 1900 includes a processor 1902, memory 1904, a storage device 1906, a high-speed interface 1908 connecting to memory 1904 and high-speed expansion ports 1910, and a low speed interface 1912 connecting to low speed bus 1914 and storage device 1906. Each of the components 1902, 1904, 1906, 1908, 1910, and 1912, are interconnected using various busses, and may be mounted on a common motherboard or in other manners as appropriate. The processor 1902 can process instructions for execution within the computing device 1900, including instructions stored in the memory 1904 or on the storage device 1906 to display graphical information for a GUI on an external input/output device, such as display 1916 coupled to high speed interface 1908. In other implementations, multiple processors and/or multiple buses may be used, as appropriate, along with multiple memories and types of memory. Also, multiple computing devices 1900 may be connected, with each device providing portions of the necessary operations, e.g., as a server bank, a group of blade servers, or a multi-processor system.

The memory 1904 stores information within the computing device 1900. In one implementation, the memory 1904 is a computer-readable medium. In one implementation, the memory 1904 is a volatile memory unit or units. In another implementation, the memory 1904 is a non-volatile memory unit or units.

The storage device 1906 is capable of providing mass storage for the computing device 1400. In one implementation, the storage device 1906 is a computer-readable medium. In various different implementations, the storage device 1906 may be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1904, the storage device 1906, or memory on processor 1902.

The high-speed controller 1908 manages bandwidth-intensive operations for the computing device 1900, while the low speed controller 1912 manages lower bandwidth-intensive operations. Such allocation of duties is exemplary only. In one implementation, the high-speed controller 1908 is coupled to memory 1904, display 1916, e.g., through a graphics processor or accelerator, and to high-speed expansion ports 1910, which may accept various expansion cards (not shown). In the implementation, low-speed controller 1912 is coupled to storage device 1906 and low-speed expansion port 1914. The low-speed expansion port, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 1900 may be implemented in a number of different forms, as shown in the figure. For example, it may be implemented as a standard server 1920, or multiple times in a group of such servers. It may also be implemented as part of a rack server system 1924. In addition, it may be implemented in a personal computer such as a laptop computer 1922. Alternatively, components from computing device 1900 may be combined with other components in a mobile device (not shown), such as device 1950. Each of such devices may contain one or more of computing device 1900, 1950, and an entire system may be made up of multiple computing devices 1900, 1950 communicating with each other.

Computing device 1950 includes a processor 1952, memory 1964, an input/output device such as a display 1954, a communication interface 1966, and a transceiver 1968, among other components. The device 1950 may also be provided with a storage device, such as a microdrive or other device, to provide additional storage. Each of the components 1950, 1952, 1964, 1954, 1966, and 1968, are interconnected using various buses, and several of the components may be mounted on a common motherboard or in other manners as appropriate.

The processor 1952 can process instructions for execution within the computing device 1950, including instructions stored in the memory 1964. The processor may also include separate analog and digital processors. The processor may provide, for example, for coordination of the other components of the device 1950, such as control of user interfaces, applications run by device 1950, and wireless communication by device 1950.

Processor 1952 may communicate with a user through control interface 1958 and display interface 1956 coupled to a display 1954. The display 1954 may be, for example, a TFT LCD display or an OLED display, or other appropriate display technology. The display interface 1956 may include appropriate circuitry for driving the display 1954 to present graphical and other information to a user. The control interface 1958 may receive commands from a user and convert them for submission to the processor 1952. In addition, an external interface 1962 may be provided in communication with processor 1952, so as to enable near area communication of device 1950 with other devices. External interface 1962 may provide, for example, for wired communication, e.g., via a docking procedure, or for wireless communication, e.g., via Bluetooth or other such technologies.

The memory 1964 stores information within the computing device 1950. In one implementation, the memory 1964 is a computer-readable medium. In one implementation, the memory 1964 is a volatile memory unit or units. In another implementation, the memory 1964 is a non-volatile memory unit or units. Expansion memory 1974 may also be provided and connected to device 1950 through expansion interface 1972, which may include, for example, a SIMM card interface. Such expansion memory 1974 may provide extra storage space for device 1950, or may also store applications or other information for device 1950. Specifically, expansion memory 1974 may include instructions to carry out or supplement the processes described above, and may include secure information also. Thus, for example, expansion memory 1974 may be provided as a security module for device 1950, and may be programmed with instructions that permit secure use of device 1950. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1964, expansion memory 1974, or memory on processor 1952.

Device 1950 may communicate wirelessly through communication interface 1966, which may include digital signal processing circuitry where necessary. Communication interface 1966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1968. In addition, short-range communication may occur, such as using a Bluetooth, WiFi, or other such transceiver (not shown). In addition, GPS receiver module 1970 may provide additional wireless data to device 1950, which may be used as appropriate by applications running on device 1950.

Device 1950 may also communicate audibly using audio codec 1960, which may receive spoken information from a user and convert it to usable digital information. Audio codec 1960 may likewise generate audible sound for a user, such as through a speaker, e.g., in a handset of device 1950. Such sound may include sound from voice telephone calls, may include recorded sound, e.g., voice messages, music files, etc., and may also include sound generated by applications operating on device 1950.

The computing device 1950 may be implemented in a number of different forms, as shown in the figure. For example, it may be implemented as a cellular telephone 1980. It may also be implemented as part of a smartphone 1982, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, certain data may be treated in one or more ways before it is stored or used, so that personally identifiable information is removed. For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

1. A computer system-implemented method comprising:
obtaining, by one or more processors, data that comprises promotions and parameters of each promotion for an opportunity;
generating, by the one or more processors, one or more transformation spaces based on a number of the promotions and the parameters of each promotion, wherein each of the one or more transformation spaces comprises a plurality of states, each state for a transformation space is based on a combination of the parameters for a particular promotion;
for at most a predefined number of iterations:
for each of the one or more transformation spaces:
adjusting, by the one or more processors, a state of the transformation space based on a set of available actions;
generating, by the one or more processors, a model by combining each adjusted state from each of the adjusted transformation spaces;
generating, by the one or more processors, metrics for the model;
based on the generated metrics, determining, by the one or more processors, an entropy of the model;
comparing, by the one or more processors, the entropy of the model to a threshold value; and
in response to determining that the entropy exceeds the threshold value, proceeding, by the one or more processors, to the next iteration; and
providing, by the one or more processors, the generated model for output to use for the opportunity.

2. The computer system-implemented method of claim 1, wherein a number of the one or more transformation spaces correspond to the number of promotions.

3. The computer system-implemented method of claim 1, further comprising:
in response to determining that a zero entropy is observed when comparing the entropy to the threshold value, providing, by the one or more processors, the generated model for output to use for the opportunity.

4. The computer system-implemented method of claim 1, wherein the parameters of the promotion comprises (i) lag transformation, (ii) adstock transformation, and (iii) fractional root transformation.

5. The computer system-implemented method of claim 4, wherein generating the one or more transformation spaces based on the number of the promotions and the parameters of each promotion further comprises:
generating, by the one or more processors, a first transformation of the lag transformation;
generating, by the one or more processors, a second transformation of the adstock transformation;
generating, by the one or more processors, a third transformation of the fractional root transformation; and
wherein each state for each of the one or more transformation spaces is based on a combination of the first transformation of the lag transformation, the second transformation of the adstock transformation, and the third transformation of the fractional root transformation.

6. The computer system-implemented method of claim 1, wherein the generated metrics comprises at least one of volume contribution functions, beta coefficient functions, p-value functions, R-square functions, DW statistic functions, and MAPE functions.

7. The computer system-implemented method of claim 6, wherein generating the entropy of the model further comprises:
generating, by the one or more processors, a distance metric for each of the generated metrics;
generating, by the one or more processors, a total summation for each of the generated metrics;
generating, by the one or more processors, a second summation that comprises a ratio based on (i) the distance metric for each of the generated metrics and (ii) the total summation;
generating, by the one or more processors, the entropy of the model based on an entropy equation and the second summation;
generating, by the one or more processors, a reward based on the entropy of the model;
generating, by the one or more processors, Q-values corresponding to actions leading to adjustments in the transformation spaces; and
storing, by the one or more processors, the Q-values corresponding to a set of prior actions corresponding to a prior adjustment state for each of the transformation spaces in a database.

8. The computer system-implemented method of claim 1, further comprising:
identifying, by one or more processors, a random state for each of the one or more transformation spaces such that (i) the random state is chosen as a starting location for exploration through each transformation space during the predefined number of iterations and (ii) the random state is chosen such that exploration can be performed within the predefined number of iterations.

9. The computer system-implemented method of claim 1, wherein adjusting the state of the transformation space is based on the set of available actions and performed using an epsilon greedy policy.

10. A system comprising:
one or more computers and one or more storage devices storing instructions that are operable, when executed by the one or more computers, to cause the one or more computers to perform operations comprising:
obtaining, by one or more processors, data that comprises promotions and parameters of each promotion for an opportunity;
generating, by the one or more processors, one or more transformation spaces based on a number of the promotions and the parameters of each promotion, wherein each of the one or more transformation spaces comprises a plurality of states, each state for a transformation space is based on a combination of the parameters for a particular promotion;
for at most a predefined number of iterations:
for each of the one or more transformation spaces:
adjusting, by the one or more processors, a state of the transformation space based on a set of available actions;
generating, by the one or more processors, a model by combining each adjusted state from each of the adjusted transformation spaces;
generating, by the one or more processors, metrics for the model;
based on the generated metrics, determining, by the one or more processors, an entropy of the model;
comparing, by the one or more processors, the entropy of the model to a threshold value; and
in response to determining that the entropy exceeds the threshold value, proceeding, by the one or more processors, to the next iteration; and
providing, by the one or more processors, the generated model for output to use for the opportunity.

11. The system of claim 10, wherein a number of the one or more transformation spaces correspond to the number of promotions.

12. The system of claim 10, further comprising:
in response to determining that a zero entropy is observed when comparing the entropy to the threshold value, providing, by the one or more processors, the generated model for output to use for the opportunity.

13. The system of claim 10, wherein the parameters of the promotion comprises (i) lag transformation, (ii) adstock transformation, and (iii) fractional root transformation.

14. The system of claim 13, wherein generating the one or more transformation spaces based on the number of the promotions and the parameters of each promotion further comprises:
generating, by the one or more processors, a first transformation of the lag transformation;
generating, by the one or more processors, a second transformation of the adstock transformation;
generating, by the one or more processors, a third transformation of the fractional root transformation; and
wherein each state for each of the one or more transformation spaces is based on a combination of the first transformation of the lag transformation, the second transformation of the adstock transformation, and the third transformation of the fractional root transformation.

15. The system of claim 10, wherein the generated metrics comprises at least one of volume contribution functions, beta coefficient functions, p-value functions, R-square functions, DW statistic functions, and MAPE functions.

16. The system of claim 15, wherein generating the entropy of the model further comprises:
generating, by the one or more processors, a distance metric for each of the generated metrics;
generating, by the one or more processors, a total summation for each of the generated metrics;
generating, by the one or more processors, a second summation that comprises a ratio based on (i) the distance metric for each of the generated metrics and (ii) the total summation;
generating, by the one or more processors, the entropy of the model based on an entropy equation and the second summation;
generating, by the one or more processors, a reward based on the entropy of the model;
generating, by the one or more processors, Q-values corresponding to actions leading to adjustments in the transformation spaces; and
storing, by the one or more processors, the Q-values corresponding to a set of prior actions corresponding to a prior adjustment state for each of the transformation spaces in a database.

17. The system of claim 10, further comprising:
identifying, by one or more processors, a random state for each of the one or more transformation spaces such that (i) the random state is chosen as a starting location for exploration through each transformation space during the predefined number of iterations and (ii) the random state is chosen such that exploration can be performed within the predefined number of iterations.

18. The system of claim 10, wherein adjusting the state of the transformation space is based on the set of available actions and performed using an epsilon greedy policy.

19. A non-transitory computer-readable medium storing software comprising instructions executable by one or more computers which, upon such execution, cause the one or more computers to perform operations comprising:
obtaining, by one or more processors, data that comprises promotions and parameters of each promotion for an opportunity;
generating, by the one or more processors, one or more transformation spaces based on a number of the promotions and the parameters of each promotion, wherein each of the one or more transformation spaces comprises a plurality of states, each state for a transformation space is based on a combination of the parameters for a particular promotion;
for at most a predefined number of iterations:
for each of the one or more transformation spaces:
adjusting, by the one or more processors, a state of the transformation space based on a set of available actions;
generating, by the one or more processors, a model by combining each adjusted state from each of the adjusted transformation spaces;
generating, by the one or more processors, metrics for the model;
based on the generated metrics, determining, by the one or more processors, an entropy of the model;
comparing, by the one or more processors, the entropy of the model to a threshold value; and
in response to determining that the entropy exceeds the threshold value, proceeding, by the one or more processors, to the next iteration; and
providing, by the one or more processors, the generated model for output to use for the opportunity.

20. The non-transitory computer-readable medium of claim 19, wherein a number of the one or more transformation spaces correspond to the number of promotions.
